(19) United States
(12) Patent Application Publication
(10) Pub. No.: US 2009/0011285 A1
(43) Pub. Date: Jan. 8, 2009

(54) MAGNETIC RECORDING MEDIUM AND METHOD FOR PRODUCING THE SAME

(75) Inventors: Kenichi NAKAMURA, Odawara-shi (JP); Yohei Aritoshi, Odawara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/166,939

(22) Filed: Jul. 2, 2008

(30) Foreign Application Priority Data
Jul. 4, 2007 (JP) 2007-176584

(51) Int. Cl. G11B 5/708

(52) U.S. Cl. 428/847.2

(57) ABSTRACT

A magnetic recording medium comprises a magnetic layer, a non-magnetic layer, an undercoat layer, a non-magnetic support, and a back coat layer formed in this order from a surface side toward a back surface side. In the magnetic recording medium, the non-magnetic support comprises a single-layer polyester-based member, and the undercoat layer contains a radiation-curable compound cured by radiation and has a film thickness of 2.0 μm or smaller, and cupping is formed in the magnetic recording medium such that an amount of cupping on the surface side is 0 mm or less. Thus, an inexpensive magnetic recording medium with excellent electromagnetic conversion characteristics can be realized.

### BACKGROUND OF THE INVENTION

1. Field of the Invention

The present invention relates to a magnetic recording medium having excellent magnetic characteristics and a method for producing the same. Particularly, the present invention relates to a magnetic recording medium which is improved in electromagnetic conversion characteristics, is produced at reduced cost, and is excellent in productivity and a method for producing the same.

2. Description of the Related Art

The digitalization of magnetic recording media has made progress in recent years for the purpose of improving deterioration in recording signals attributed to repetitive copying. Along with this, the amount of data recorded is increased, and media have been demanded to have a higher recording density. Such a higher recording density requires reducing the thickness loss or self-demagnetization loss of media. Thus, a reduction in thickness of a magnetic layer has been studied.

However, when a magnetic layer becomes thinner, the surface nature of a non-magnetic support may influence the surface nature of the magnetic layer, resulting in deteriorated electromagnetic conversion characteristics. To prevent such adverse influence of surface nature of a non-magnetic support, a technique has been proposed in recent years, in which a magnetic layer is provided via a non-magnetic layer provided on the surface of a support. For example, Japanese Patent Application Laid-Open Nos. 63-191315 and 63-191318 disclose a method for preparing a magnetic recording medium having such a multilayer structure. This technique involves: dispersing non-magnetic particles into a thermoplastic resin binder to constitute an application solution for a non-magnetic layer, which is then applied onto a non-magnetic support to form a non-magnetic layer; and applying an application solution for a magnetic layer onto this non-magnetic layer placed in a wet state (hereinafter, also referred to as “simultaneous multilayer coating (method)”).

Alternatively, an approach for improving electromagnetic conversion characteristics has been proposed, in which an undercoat layer (smoothing coating layer) is provided between a non-magnetic support and a non-magnetic layer. For example, Japanese Patent Application Laid-Open Nos. 2003-281710 and 2004-334988 disclose such an undercoat layer provided therebetween. The undercoat layer disclosed therein has a radiation-curable compound.

On the other hand, it has also been proposed that a support further improved in surface nature is used in a magnetic recording medium. For example, Japanese Patent Application Laid-Open Nos. 3-224127 and 2002-1809 disclose the use of a non-magnetic support having a layered structure having a smooth layer on the side where a magnetic layer is applied.

### SUMMARY OF THE INVENTION

A non-magnetic support having a smooth surface is poor in handleability in production steps thereof and is therefore produced at higher cost. Particularly, a non-magnetic support used in the preparation of a magnetic recording medium having a large capacity and a high recording density is prepared in a thin form. Such a non-magnetic support is therefore poor in handleability and yield and is exceedingly expensive. Alternatively, a non-magnetic support having a layered structure improved in handleability has been proposed in which a smooth layer for improving surface nature and handleability is formed on the side where a magnetic layer is applied while a filler is added to the opposite side to make the surface rough. Even such a non-magnetic support does not produce the effect of sufficiently reducing production cost. The price of such a non-magnetic support is also reflected in the price of a magnetic recording medium. Thus, the higher price of a non-magnetic support leads to the higher price of a magnetic recording medium. On the other hand, a non-magnetic support having both surfaces that are not so smooth not only has favorable handleability in production steps thereof but also can be produced at significantly reduced cost. Thus, the use of such a non-magnetic support can significantly reduce the price of a magnetic recording medium.

As a result of various studies, it has been demonstrated that when a method is adopted, in which an undercoat layer containing a radiation-curable compound is provided to thereby smooth the surface of a non-magnetic support, cupping which is concave on the side having the undercoat layer (on the side having a magnetic layer) and is convex on the side having a back coat layer tends to be formed in a magnetic recording medium. This is due to the volume shrinkage of the undercoat layer caused by the cure of the radiation-curable compound used in the undercoat layer.

It is preferred that cupping which is convex on the side having a magnetic layer should be formed in a magnetic recording medium. When cupping which is concave on the side having a magnetic layer is formed in a magnetic recording medium, such a magnetic recording medium may suffer damage such as cutting resulting from the contact between a tape edge thereof and a magnetic head or may form excessive space between a magnetic head and the magnetic recording medium. In such a state, information input/output in the magnetic layer of the magnetic recording medium using a magnetic head causes errors attributed to dust produced from the damaged tape edge or errors attributed to the spacing between the magnetic head and the magnetic recording medium. However, the use of a magnetic recording medium having cupping which is convex on the side having a magnetic layer can reduce the occurrence of such errors.

If improvement in the surface nature of a magnetic layer as well as cupping which is convex on the side having the magnetic layer can be achieved using a support having both surfaces that are moderately rough, an inexpensive magnetic recording medium excellent in electromagnetic conversion characteristics can be prepared.

On the other hand, when a method is adopted, in which an application solution for each layer is layered in a wet state to form a non-magnetic layer and a magnetic layer (simultaneous multilayer coating method), the non-magnetic layer and the magnetic layer may be mixed at their interface, resulting in deteriorated electromagnetic conversion characteristics or yields. Particularly, the use of a thinner magnetic layer for achieving a higher recording density significantly deteriorates electromagnetic conversion characteristics or yields. By contrast, when a method is adopted which comprises: applying an application solution for a non-magnetic layer onto a non-magnetic support and drying the application solution for a non-magnetic layer to thereby temporarily form a non-magnetic layer; and then forming a magnetic layer onto the non-magnetic layer (hereinafter, also referred to as “successive multilayer coating (method)”), the mixing between the non-magnetic layer and the magnetic layer at their interface can be reduced. Therefore, this method is effective for improving electromagnetic conversion characteristics and yields.

Moreover, productivity is also improved by continuously forming layers constituting a magnetic recording medium on a non-magnetic support sent from a non-magnetic support master roll.

The present invention has been achieved in consideration of such situations. An object of the present invention is to provide an inexpensive magnetic recording medium excellent in electromagnetic conversion characteristics.

A further object of the present invention is to provide a method capable of producing the magnetic recording medium in large amounts.

One aspect of the present invention relates to a magnetic recording medium comprising, in order from a surface side toward a back surface side: a magnetic layer; a non-magnetic layer; an undercoat layer; a non-magnetic support; and a back coat layer, wherein the non-magnetic support comprises a single-layer polyester-based member, the undercoat layer contains a radiation-curable compound which has been cured by radiation and has a film thickness of 2.0 μm or smaller, and cupping is formed such that an amount of cupping on the surface side is 0 mm or less.

Preferably, the amount of cupping is 0 mm to −2.0 mm.

Preferably, the non-magnetic support comprises a polyester-based member mainly composed of polyethylene-2,6-naphthalene dicarboxylate. Polyethylene-2,6-naphthalene dicarboxylate (PEN) is preferable as a material for the non-magnetic support, for example, in terms of rigidity.

Preferably, the non-magnetic support has a film thickness of 10 μm or smaller, contains first inactive fine particles having an average particle size (D50) of 0.05 μm or larger and smaller than 1.5 μm and comprising at least one or more components, is free from inactive fine particles having an average particle size (D50) of 1.5 μm or larger, and has a center line average surface roughness of 1 nm or more and 50 nm or less on the surface side.

Such a non-magnetic support is excellent in handleability and can constitute a magnetic recording medium having favorable electromagnetic conversion characteristics Preferably, the first inactive fine particles comprise at least one of silica fine particles (SiO₂) and silicone fine particles (resin).

Preferably, second inactive fine particles having the largest average particle size (D50) among inactive fine particles contained in the non-magnetic support, are monodisperse fine particles in a spherical form having a particle size distribution value (D25/D75) of 2.0 or less. The second inactive fine particles may be the same as or different from the inactive particles described above.

Preferably, the magnetic recording medium is produced by: applying an application solution for an undercoat layer containing the radiation-curable compound onto the non-magnetic support and then drying the application solution for an undercoat layer while curing the radiation-curable compound to thereby form the undercoat layer; after the drying of the undercoat layer and the cure of the radiation-curable compound, applying an application solution for a non-magnetic layer onto the undercoat layer and drying the application solution for a non-magnetic layer to thereby form the non-magnetic layer; and after the formation of the non-magnetic layer, applying an application solution for a magnetic layer onto the non-magnetic layer and drying the application solution for a magnetic layer to thereby form the magnetic layer.

Preferably, the undercoat layer is substantially free from particles comprising an inorganic compound and particles comprising an organic compound.

The term “particles” described herein conceptionally encompasses, for example, particles having a size larger than the film thickness of the undercoat layer. Moreover, the phrase “substantially free from” means a range that substantially causes no loss of the functions of the undercoat layer in the magnetic recording medium and refers to, for example, the range of 0.1% by mass or lower with respect to the undercoat layer.

Preferably, the undercoat layer comprises a migration component to migrate into the non-magnetic layer or the magnetic layer, and the radiation-curable compound is cured such that the migration component in the undercoat layer has a concentration of 10% by mass or lower.

The phrase “the migration component has a concentration of 10% by mass or lower” described herein refers to a value obtained after the cure of the radiation-curable compound.

Preferably, the undercoat layer is free from a migration component to migrate into the non-magnetic layer or the magnetic layer.

Preferably, the radiation-curable compound contained in the undercoat layer is cured such that the volume shrinkage of the undercoat layer is 20% or less.

The volume shrinkage of the undercoat layer can be changed appropriately, for example, by adjusting components constituting the undercoat layer or adjusting the degree of cure of the radiation-curable compound.

Preferably, the radiation-curable compound contained in the undercoat layer is cured in an atmosphere with an oxygen concentration of 1000 ppm or lower.

Preferably, the magnetic layer comprises a powdery ferromagnet and a binder, the binder comprising a resin having a mass-average molecular weight of 120,000 or larger.

Such a magnetic layer can effectively disperse the powdery ferromagnet and can prevent the occurrence of oriented aggregation. One example of a preferable binder can include a binder containing a resin having a mass-average molecular weight of approximately 170,000 and a binder containing a urethane-based or vinyl chloride-based substance.

Preferably, the surface of the magnetic recording medium on the side where the magnetic layer is formed relative to the non-magnetic support has a center line average surface roughness of 10 nm or less and has protrusions having a height of 10 nm or higher and 20 nm or lower at a rate of 1 to 500 pieces/100 μm².

Another aspect of the present invention relates to a method for producing such a magnetic recording medium, comprising the steps of: continuously forming an undercoat layer, a non-magnetic layer, and a magnetic layer in this order onto a non-magnetic support sent from a non-magnetic support master roll to thereby obtain a magnetic recording medium web, which is then winded to produce a magnetic recording medium master roll; and cutting the magnetic recording medium web unwound from the magnetic recording medium master roll into tapes.

According to the present invention, a magnetic recording medium capable of high-density recording with a large capacity can be produced using an inexpensive non-magnetic support. Thus, an inexpensive magnetic recording medium excellent in electromagnetic conversion characteristics can be produced.

According to the present invention, an undercoat layer, a non-magnetic layer, and a magnetic layer are continuously formed onto a non-magnetic support sent from a non-magnetic support master roll. After the formation of the undercoat layer, the non-magnetic layer, and the magnetic layer, the non-magnetic support on which these layers have been formed is winded to thereby obtain a magnetic recording medium master roll. Then, a portion of this magnetic recording medium master roll is cut to obtain a magnetic recording medium in a tape form. Thus, the magnetic recording medium can be produced in large amounts.

### BRIEF DESCRIPTION OF THE DRAWINGS

FIG. 1 is a diagram showing the cross section of a magnetic recording medium according to one embodiment of the present invention;

FIG. 2 is a cross-sectional diagram showing a magnetic recording medium tape viewed parallel to the longitudinal direction;

FIG. 3 is a schematic diagram showing one example of a production line of a magnetic recording medium;

FIGS. 4A and 4B are diagrams showing evaluation test results; and

FIGS. 5A and 5B are diagrams showing evaluation test results.

### DETAILED DESCRIPTION OF THE PREFERRED EMBODIMENTS

Hereinafter, embodiments of the present invention will be described in detail with reference to the drawings. In descriptions below, the structure and composition of a magnetic recording medium will be described first. Subsequently, a method for producing the magnetic recording medium will be described. Finally, Examples according to the present invention will be described.

### (Magnetic Recording Medium)

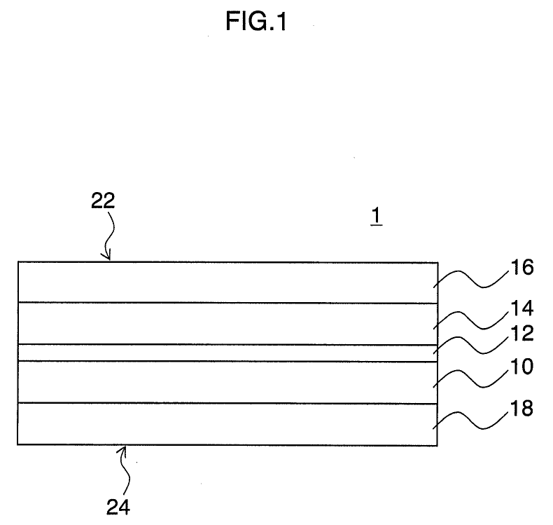

FIG. 1 is a diagram showing the cross section of a magnetic recording medium according to one embodiment of the present invention. A magnetic recording medium 1 comprises: a non-magnetic support 10; a back coat layer 18 formed on a tape back surface side of the non-magnetic support 10; and an undercoat layer 12, a non-magnetic layer 14, and a magnetic layer 16 layered in this order on a surface side of the non-magnetic support 10. Thus, the undercoat layer 12, the non-magnetic layer 14, and the magnetic layer 16 are provided on the side opposite to the back coat layer 18 via the non-magnetic support 10. A tape surface 22 is formed by the magnetic layer 16, while a tape back surface 24 is formed by the back coat layer 18.

The non-magnetic support 10 used in the magnetic recording medium 1 comprises a single-layer polyester-based member. Moreover, the undercoat layer 12 contains a radiation-curable compound which has been cured by radiation and has a film thickness of 2.0 μm or smaller. In the magnetic recording medium 1, cupping is formed in an amount that forms cupping which is convex on the tape surface 22 side.

The amount of cupping in the magnetic recording medium 1 is measured, for example, as follows:

A 1-m portion of a magnetic recording medium tape is cut, and the cut magnetic recording medium tape is kept in a measurement atmosphere (23° C., 50% RH) for 24 hours. Then, a 300-mm center portion in the longitudinal direction of the magnetic recording medium tape is cut, and the cut magnetic recording medium tape is left standing on a flat panel for 3 hours in a state where the tape surface formed by the magnetic layer is faced up. Then, this magnetic recording medium tape is placed on a flat table in a free state such that the tape surface (magnetic layer) is located on the upper side. In such a case, the amount of cupping is indicated in a minus (−) sign when the magnetic recording medium tape is deformed into a convex shape relative to the tape width direction such that the tape surface (magnetic layer) protrudes upwardly. On the other hand, the magnetic recording medium tape is placed on a flat table in a free state such that the tape back surface (back coat layer) is located on the upper side. In such a case, the amount of cupping is indicated in a plus (+) sign when the magnetic recording medium tape takes a shape where the tape back surface (back coat layer) protrudes upwardly. Alternatively, the amount of cupping is defined as zero (0) when the magnetic recording medium tape keeps its flat shape.

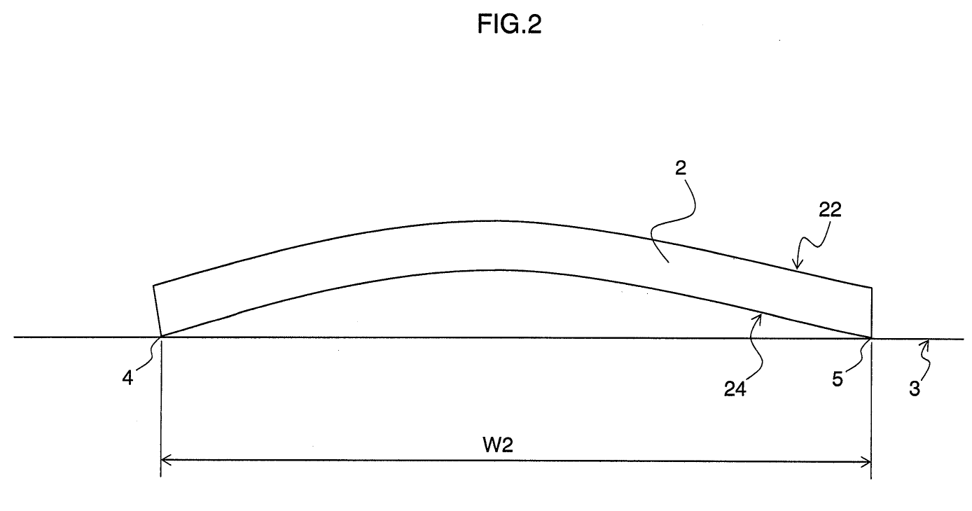

FIG. 2 is a cross-sectional diagram showing a magnetic recording medium tape 2 viewed parallel to the longitudinal direction. Cupping that forms a convex shape of the magnetic recording medium tape on the side having the magnetic layer (on the tape surface 22 side) refers to a state where when the tape fragment 2 collected by cutting perpendicular to the longitudinal direction is placed on a plane 3 in a tension-free state such that a tape back surface 24 formed by the back coat layer is located on the lower side, both tape ends 4 and 5 in the tape width direction come into contact with the plane 3 but the tape back surface 24 does not come into contact with the plane 3 such that the cross-sectional shape of the tape fragment 2 takes a convex shape.

The amount of cupping in the magnetic recording medium is calculated, for example, as follows: a 300-mm central portion of the magnetic recording medium is cut as described above to obtain a magnetic recording medium tape having a length of 100 mm, and a tape width W2 (see FIG. 2) of this magnetic recording medium tape during cupping is measured with a comparator. On the other hand, the same sample of the magnetic recording medium tape is covered with slide glass, and a tape width W1 (not shown) thereof is measured. The amount of cupping is calculated based on these measurement values and the following formula:

Amount of cupping=(W2/2)tan(S^{1/2}), wherein

S=10×{1−(1.2×W2/W1−0.2)^{1/2}}.

In the present embodiment, it is preferred that cupping which is convex on the magnetic layer side should be formed in the magnetic recording medium. The amount of cupping per ½-inch width is preferably 0 mm or less and −2.0 mm or more, more preferably, smaller than 0 mm and −2.0 mm or more, even more preferably −0.05 mm or less and -1.5 mm or more, particularly preferably −0.1 mm or less and −1.0 mm or more.

When cupping which is concave on the side having the magnetic layer is formed in the magnetic recording medium (i.e., the amount of cupping is plus), this magnetic recording medium may suffer the damage of a tape edge thereof or damage such as cutting resulting from the contact between the tape edge and a magnetic head or may form excessive space between a magnetic head and the magnetic recording medium. In such a state, information input/output in the magnetic layer using a magnetic head particularly easily causes errors attributed to dust produced from the damaged tape edge or errors attributed to the spacing between the magnetic head and the magnetic recording medium.

Alternatively, if the amount of cupping exceeds -2.0 mm, such errors attributed to dust produced from the tape edge by cutting hardly occur but the errors attributed to the spacing between the magnetic head and the magnetic recording medium slightly easily occur.

On the other hand, according to the present embodiment, cupping which is convex on the magnetic layer side is formed in the magnetic recording medium, and the amount of cupping is specified as described above. Thus, a magnetic recording medium can be provided which accurately achieves information input/output using a magnetic head by preventing the occurrence of errors.

As shown in FIG. 1, the undercoat layer 12 is applied between the single-layer polyester-based non-magnetic support 10 and the non-magnetic layer 14. In general, the use of the undercoat layer 12 containing a radiation-curable compound tends to form cupping which is concave on the side having the magnetic layer 16 (on the surface side). This is due to the volume shrinkage of the undercoat layer 12 caused by the cure of the radiation-curable compound.

Cupping in the magnetic recording medium 1 can be controlled by adjusting the balance between the shrinkage of the back coat layer 18 provided on the back surface side of the non-magnetic support 10 and the shrinkage of the undercoat layer 12, the non-magnetic layer 14, and the magnetic layer 16 provided on the surface side of the non-magnetic support 10. For example, a rich coat of the back coat layer 18 that is highly shrinkable is applied on the non-magnetic support 10 to secure, on the side having the back coat layer 18 (on the tape back surface side), shrinkability exceeding that on the side having the magnetic layer 16 (on the tape surface side). As a result, cupping can be formed in the magnetic recording medium 1 such that the magnetic recording medium 1 protrudes in a convex shape on the side having the magnetic layer. Alternatively, a light coat of the non-magnetic layer 14 or the magnetic layer 16 is applied onto the non-magnetic support 10 to reduce shrinkability on the side having the magnetic layer 16. As a result, cupping can be formed in the magnetic recording medium 1 such that the magnetic recording medium 1 protrudes in a convex shape on the side having the magnetic layer. However, the application of a rich coat of the back coat layer 18 may cause a loss of flatness of the magnetic recording medium 1, the inhibition of a larger capacity attributed to an increased total thickness of the magnetic recording medium 1, surface failures such as uneven application, and other various harmful effects. On the other hand, a decreased film thickness of the non-magnetic layer 14 leads to harmful effects such as a loss of the surface smoothness of the magnetic layer 16.

As a result of various studies, it has been demonstrated that the use of a single-layer polyester-based support, compared with the use of a layered polyester-based support, can form cupping such that the magnetic recording medium protrudes in a convex shape on the side having the magnetic layer (on the tape surface side), even when totally the same back coat layer, undercoat layer, non-magnetic layer, or magnetic layer is applied thereonto.

Specifically, when an undercoat layer is used which contains a radiation-curable compound and shrinks in volume, the use of the single-layer polyester-based support can produce a magnetic recording medium with better quality than the use of a layered polyester-based support and is therefore preferable.

A smooth surface of the single-layer polyester-based support used in the present embodiment is not always preferable from the viewpoint of securing favorable handleability and achieving low cost in production steps thereof. It is rather preferred that the support should have a moderate surface roughness. Preferably, the single-layer polyester-based support used in the present embodiment has a film thickness of 10 μm or smaller, contains at least one or more types of inactive fine particles having an average particle size (D50) of 0.05 μm or larger and smaller than 1.5 μm, is free from inactive fine particles having an average particle size (D50) of 1.5 μm or larger, and has a center line average surface roughness (Ra) of 1 nm or more and 50 nm or less on the side where the magnetic layer is applied (on the tape surface side).

On the other hand, the electromagnetic conversion characteristics of the magnetic recording medium are influenced by the surface roughness of the magnetic layer. A smooth surface of the magnetic layer produces higher electromagnetic conversion characteristics. The undercoat layer used in the present embodiment effectively prevents the surface nature of the non-magnetic support with a not so smooth surface from influencing the surface nature of the magnetic layer, resulting in deteriorated electromagnetic conversion characteristics.

Specifically, the magnetic recording medium used in the present embodiment is preferably produced by: applying an application solution for forming an undercoat layer containing the radiation-curable compound onto the single-layer non-magnetic support and then drying the application solution for forming an undercoat layer while curing the radiation-curable compound to thereby form the undercoat layer; then applying an application solution for a non-magnetic layer onto the undercoat layer and then drying the application solution for a non-magnetic layer to thereby form the non-magnetic layer on the undercoat layer; and then applying an application solution for a magnetic layer onto the non-magnetic layer and then drying the application solution for a magnetic layer to thereby form the magnetic layer on the non-magnetic layer. Such a so-called successive multilayer coating method can prevent the mixing between adjacent layers and is therefore very preferable. For example, the non-magnetic layer and the magnetic layer, when produced by a simultaneous multilayer coating method, tend to be mixed at their interface. Particularly, in a magnetic recording medium provided with a thin magnetic layer, this mixing at the interface causes deteriorated electromagnetic conversion characteristics and yields. By contrast, according to the magnetic recording medium of the present embodiment formed based on the successive multilayer coating method, the mixing between the non-magnetic layer and the magnetic layer at their interface can be reduced, and electromagnetic conversion characteristics and yields can be improved.

In the magnetic recording medium formed by the successive multilayer coating method, the mixing between the non-magnetic layer and the magnetic layer is low. Therefore, when the magnetic recording medium is etched from the surface of the magnetic layer (tape surface) toward the depth direction and subjected to compositional analysis, evidently different composition can be observed between both sides of the interface between the non-magnetic layer and the magnetic layer. By contrast, in a magnetic recording medium formed by the simultaneous multilayer coating method, mixing occurs between the non-magnetic layer and the magnetic layer at their interface. Therefore, the same analysis shows no evidently different composition between both sides of the interface. Thus, based on such different composition between both sides of the interface, a medium formed by the simultaneous multilayer coating method can be distinguished easily from a medium formed by the successive multilayer coating method.

When magnetic layers having the same thicknesses are formed using the same application solutions, a value of interface fluctuation between the non-magnetic layer and the magnetic layer is smaller in the magnetic recording medium formed by the successive multilayer coating method than in a magnetic recording medium formed by the simultaneous multilayer coating method. Thus, based on the difference in interface fluctuation between the non-magnetic layer and the magnetic layer, a medium formed by the simultaneous multilayer coating method can be distinguished from a medium formed by the successive multilayer coating method. For example, interface fluctuation between the non-magnetic layer and the magnetic layer in the magnetic recording medium in a tape form can be measured based on a method described below.

The cross section of the magnetic recording medium (tape) in the longitudinal direction is observed at a magnification of 100,000 times using a Transmission Electron Microscope (TEM). The magnetic recording medium is cut to form this cross section. In this case, an epoxy resin can be used in treatment for embedding the magnetic recording medium. The cross section of the magnetic recording medium having a length of 10 μm is analyzed with an image analyzer. A thickness d of the magnetic layer and standard deviation σ thereof are determined. A coefficient Da of interface fluctuation between the non-magnetic layer and the magnetic layer can be determined based on the formula “Da=(σ/d)×100 (%)”.

The surface roughness of the magnetic layer, which influences electromagnetic conversion characteristics, can be evaluated preferably using an atomic force microscope (AFM). A lower center line average surface roughness (Ra) is more preferable for the surface of the magnetic layer.

The center line average surface roughness (Ra) of the magnetic layer is preferably 10.0 nm or less. Preferably, the surface of the magnetic layer has fine protrusions having a height of 10 nm to 20 nm at a rate of 1 to 500 pieces/100 μm².

Next, each layer constituting the magnetic recording medium of the present embodiment will be described in detail.

### (Non-Magnetic Support)

In the present embodiment, a single-layer polyester-based support is used as a non-magnetic support. Polyester is a polymer that is obtained by the polycondensation of aromatic dicarboxylic acid such as terephthalic acid or 2,6-naphthalene dicarboxylic acid with aliphatic glycol such as ethylene glycol, diethylene glycol, or 1,4-cyclohexanedimethanol. The polymer may be a homopolymer or may be a copolymer containing a third component. In this case, for example, one or two or more of isophthalic acid, phthalic acid, terephthalic acid, 2,6-naphthalene dicarboxylic acid, adipic acid, sebacic acid, and oxycarboxylic acid (e.g., p-oxybenzoic acid) may be used as a dicarboxylic acid component. One or two or more of ethylene glycol, propylene glycol, butanediol, 1,4-cyclohexanedimethanol, neopentyl glycol, diethylene glycol, and triethylene glycol may be used as a glycol component.

In the present embodiment, a polyester-based support which contains polyethylene terephthalate (PET) or polyethylene-2,6-naphthalene dicarboxylate (PEN) as a main component is preferable. When PET or PEN is adopted as a main component in the non-magnetic support, it is also preferred that the non-magnetic support should be composed mainly of a polymer obtained by copolymerization with 5% by mol or more of any third component selected from among isophthalic acid, terephthalic acid, 2,6-naphthalene dicarboxylic acid, 1,4-cyclohexanedimethanol, 1,4-butanediol, and diethylene glycol with respect to the total amount of acid components or glycol components.

Preferably, the main component in the non-magnetic support has a glass transition temperature of 100° C. or higher. In this regard, PEN is most preferable. Preferable examples of the non-magnetic support mainly composed of PEN are described in, for example, Japanese Patent Application Laid-Open Nos. 2005-329548 and 2005-330311.

A thinner film thickness of the non-magnetic support is more preferable for preparing a magnetic recording medium having a large capacity. Preferably, the support used in the present embodiment has a film thickness of 10 μm or smaller, more preferably 2 to 8 μm, even more preferably 3 to 7 μm, particularly preferably 4 to 6 μm. If the film thickness of the support is smaller than 2 μm, the magnetic recording medium tends to be cut in use. If the film thickness of the support exceeds 10 μm, a magnetic recording medium having a larger capacity is difficult to achieve.

It is preferred that the support used in the present embodiment should be as inexpensive as possible. The poor handleability of the support in production steps thereof deteriorates yields, and a magnetic recording medium comprising such a support is therefore produced at high cost. Thus, it is preferred that the support used in the present embodiment should contain inactive fine particles and have a not so smooth surface. Preferable inactive fine particles used in the support will be described later.

Preferably, the surface (surface on the side where the magnetic layer is applied) of the single-layer polyester-based support used in the present embodiment has a center line average surface roughness (Ra) of 1 nm or more and 50 nm or less, more preferably 1 nm or more and 25 nm or less, even more preferably 2 nm or more and 15 nm or less, particularly preferably 3 nm or more and 10 nm or less. If the center line average surface roughness (Ra) of the surface of the support is 1 nm or less, the effect of improving handleability is difficult to obtain in production steps of the magnetic recording medium. If the center line average surface roughness (Ra) of the surface of the support exceeds 50 nm, the film thickness of the undercoat layer must be increased. Therefore, such a center line average surface roughness (Ra) is not preferable.

The center line average surface roughness of the support can be measured, for example, by using a versatile three-dimensional surface structure analyzer NewView series manufactured by Zygo Corporation.

Preferably, the support used in the present embodiment has a heat shrinkage of 3% or less, more preferably 1.5% or less, after being left for 30 minutes in an atmosphere of 100° C. and has a heat shrinkage of 1% or less, more preferably 0.5% or less, after being left for 30 minutes in an atmosphere of 80° C. Preferably, the support has: breaking strength of 5 to 100 kg/mm² (49 to 980 MPa); a modulus of elasticity of 100 to 2000 kg/mm² (0.98 to 19.6 GPa); a temperature coefficient of expansion of 10⁻⁴ to 10⁻⁸/° C., more preferably 10⁻⁵ to 10⁻⁶/° C.; and a humidity coefficient of expansion of 10⁻⁴/RH % or less, more preferably 10⁻⁵/RH % or less. It is preferred that these thermal, dimensional, and mechanical strength properties of the support should be almost equal in all directions of in-plane and should specifically differ by 10% or smaller among these directions.

The support may be subjected to various treatments such as corona discharge, plasma, heat, or dust removal treatment.

### (Inactive Fine Particles)

Preferably, the single-layer polyester-based support used in the present embodiment contains inactive fine particles for improving handleability in production steps, as described above.

Particularly preferably, the support contains at least one or more types of inactive fine particles having an average particle size of 0.05 μm or larger and is free from inactive fine particles having an average particle size of 1.5 μm or larger. Even if the support contains inactive fine particles having an average particle size smaller than 0.05 μm, the effect of improving the handleability of the support is difficult to obtain in production steps. On the other hand, if the support contains inactive fine particles having an average particle size of 1.5 μm or larger, a rich coat of the undercoat layer must be applied to prevent the surface nature of the support from influencing the surface nature of the magnetic layer. Therefore, such a support is not preferable.

The average particle size of the inactive fine particles is preferably 0.05 to 1.0 μm, more preferably 0.07 to 0.7 μm, even more preferably 0.1 to 0.5 μm, particularly preferably 0.1 to 0.3 μm. The average particle size can be measured, for example, by an approach which involves converting measurement values obtained based on electron micrography into an equivalent sphere and defining a particle size (D50) that shows 50% with respect to the whole volume as an average particle size.

Examples of components in the inactive fine particles include kaolin, talc, titanium dioxide, silicon dioxide (silica), calcium phosphate, aluminum oxide, zeolite, lithium fluoride, calcium fluoride, barium sulfate, carbon black, and fine powders of a heat-resistant polymer described in Japanese Examined Application Publication No. 59-5216.

Preferably, at least one type of the inactive fine particles is any of silicon dioxide (silica) fine particles and silicone fine particles. The silica fine particles or the silicone fine particles can be synthesized such that these particles have various sizes and particle size distributions. Moreover, these particles are inexpensive.

Preferably, of the inactive fine particles contained in the non-magnetic support, inactive fine particles having the largest average particle size (D50) are monodisperse particles having a particle size distribution value (D25/D75) of 2.0 or less and are fine particles in a spherical form having a narrow particle size distribution. More preferably, the inactive fine particles having the largest average particle size (D50) has a particle size distribution value (D25/D75) of 1.7 or less, even more preferably 1.5 or less, particularly preferably 1.3 or less. The use of the fine particles having a narrow particle size distribution can form a large number of protrusions having an exceedingly uniform height and shape on the surface of the support. On the other hand, fine particles having a wide particle size distribution include a large number of coarse particles. The use of such fine particles therefore tends to form large protrusions on the surface of the support. Thus, a rich coat of the undercoat layer must be applied.

The particle size distribution can be calculated by measuring an integrated volume of the particles from the largest particles and using, as a particle size distribution value, a ratio (D25/D75) of a particle size (D25) that shows 25% with respect to the whole volume to a particle size (D75) that shows 75% with respect thereto.

Examples of the monodisperse fine particles include organic particles such as crosslinked polymer particles described in, for example, Japanese Patent Application Laid-Open No. 59-217755 and inorganic fine particles such as silica, titania, alumina, and zirconia. Crosslinked polymer fine particles (e.g., crosslinked polystyrene) or silica fine particles in a spherical form are more preferable. Silica fine particles or silicone fine particles in a spherical form are particularly preferable. Examples of commercially available products thereof include Seahostar (manufactured by Nippon Shokubai Co., Ltd.) and Tospearl (manufactured by Nissho Sangyo Co., Ltd.).

Two or more types of inactive fine particles can also be used in combination. For example, monodisperse fine particles and other particles can be used in combination; inactive fine particles differing in type can be used in combination; inactive fine particles differing in particle size can be used in combination; or inactive fine particles differing both in type and in particle size can be used in combination.

The inactive fine particles can be subjected to surface treatment for improving dispersibility in the polymer. In this case, examples of surface treatment agents used include surface treatment agents described in Japanese Patent Application Laid-Open Nos. 59-69426 and 1-256558. Particularly, for example, polycarboxylic acid or a sodium salt or ammonium salt thereof, silane coupling agents, and titanate coupling agents are preferable.

The amount of the inactive fine particles added is preferably 0.001 to 5% by mass, more preferably 0.01 to 3% by mass, particularly preferably 0.05 to 1% by mass, with respect to the non-magnetic support.

### (Undercoat Layer)

The radiation-curable compound used in the undercoat layer of the present embodiment is a compound having a radiation-curable functional group and is contained in the undercoat layer to obtain the desired undercoat effect. The radiation-curable compound has the property of being polymerized or crosslinked through energy imparted by radiation such as electron beams or ultraviolet rays to form a polymer. The radiation-curable compound in the undercoat layer is polymerized or crosslinked and cured. As a result, the whole undercoat layer can also be cured to obtain high coating strength.

Moreover, an application solution containing the radiation-curable compound can produce high coating smoothness. This is because the radiation-curable compound has a relatively low viscosity, and the undercoat layer containing such a radiation-curable compound has a high effect of blocking pinholes or protrusions on the surface of the support by virtue of leveling effects after application. Thus, the non-magnetic layer and the magnetic layer are applied onto the undercoat layer according to the present embodiment to obtain a magnetic layer excellent in smoothness. Therefore, a magnetic recording medium having excellent electromagnetic conversion characteristics can be prepared. This effect is particularly prominent in a magnetic layer having a relatively thin film thickness of 0.01 μm to 1.0 μm. Protrusions attributed to the surface nature of the support are reduced on the surface of the magnetic layer having such a film thickness. Thus, a noise in magnetic recording using an MR head used for a higher recording density can be reduced effectively.

Examples of the radiation-curable compound can include acrylic acid esters, acrylamides, methacrylic acid esters, methacrylic acid amides, allyl compounds, vinyl ethers, and vinyl esters. Among them, acrylic acid esters and methacrylic acid esters are preferable. Particularly, acrylic acid esters having two or more radiation-curable functional groups (acryloyl groups) are preferable. Acrylic acid esters having two acryloyl groups are preferable from the viewpoint of reducing volume shrinkage attributed to crosslinking or polymerization.

Specific examples of the radiation-curable compound having two acryloyl groups include cyclopropane diacrylate, cyclopentane diacrylate, cyclohexane diacrylate, cyclobutane diacrylate, dimethylolcyclopropane diacrylate, dimethylolcyclopentane diacrylate, dimethylolcyclohexane diacrylate, dimethylolcyclobutane diacrylate, cyclopropane dimethacrylate, cyclopentane dimethacrylate, cyclohexane dimethacrylate, cyclobutane dimethacrylate, dimethylolcyclopropane dimethacrylate, dimethylolcyclopentane dimethacrylate, dimethylolcyclohexane dimethacrylate, dimethylolcyclobutane dimethacrylate, bicyclobutane diacrylate, bicyclooctane diacrylate, bicyclononane diacrylate, bicycloundecane diacrylate, dimethylolbicyclobutane diacrylate, dimethylolbicyclooctane diacrylate, dimethylolbicyclononane diacrylate, bicyclobutane dimethacrylate, bicyclooctane dimethacrylate, bicyclononane dimethacrylate, bicycloundecane dimethacrylate, dimethylolbicyclobutane dimethacrylate, dimethylolbicyclooctane dimethacrylate, dimethylolbicyclononane dimethacrylate, dimethylolbicycloundecane dimethacrylate, tricycloheptane diacrylate, tricyclodecane diacrylate, tricyclododecane diacrylate, tricycloundecane diacrylate, tricyclotetradecane diacrylate, tricyclodecanetridecane diacrylate, dimethyloltricycloheptane diacrylate, dimethyloltricyclodecane diacrylate, dimethyloltricyclododecane diacrylate, dimethyloltricycloundecane diacrylate, dimethyloltricyclotetradecane diacrylate, dimethyloltricyclodecanetridecane diacrylate, tricycloheptane dimethacrylate, tricyclodecane dimethacrylate, tricyclododecane dimethacrylate, tricycloundecane dimethacrylate, tricyclotetradecane dimethacrylate, tricyclodecanetridecane dimethacrylate, dimethyloltricycloheptane dimethacrylate, dimethyloltricyclodecane dimethacrylate, dimethyloltricyclododecane dimethacrylate, dimethyloltricycloundecane dimethacrylate, dimethyloltricyclotetradecane dimethacrylate, dimethyloltricyclodecanetridecane dimethacrylate, spirooctane diacrylate, spiroheptane diacrylate, spirodecane diacrylate, cyclopentanespirocyclobutane diacrylate, cyclohexanespirocyclopentane diacrylate, spirobicyclohexane diacrylate, dispiroheptadecane diacrylate, dimethylolspirooctane diacrylate, dimethylolspiroheptane diacrylate, dimethylolspirodecane diacrylate, dimethylolcyclopentanespirocyclobutane diacrylate, dimethylolcyclohexanespirocyclopentane diacrylate, dimethylolspirobicyclohexane diacrylate, dimethyloldispiroheptadecane diacrylate, spirooctane dimethacrylate, spiroheptane dimethacrylate, spirodecane dimethacrylate, cyclopentanespirocyclobutane dimethacrylate, cyclohexanespirocyclopentane dimethacrylate, spirobicyclohexane dimethacrylate, dispiroheptadecane dimethacrylate, dimethylolspirooctane dimethacrylate, dimethylolspiroheptane dimethacrylate, dimethylolspirodecane dimethacrylate, dimethylolcyclopentanespirocyclobutane dimethacrylate, dimethylolcyclohexanespirocyclopentane dimethacrylate, dimethylolspirobicyclohexane dimethacrylate, and dimethyloldispiroheptadecane dimethacrylate.

It is also preferred that a radiation-curable compound having an alicyclic ring structure should used as the radiation-curable compound contained in the undercoat layer of the present embodiment. The alicyclic ring structure has a skeleton such as a cyclo, bicyclo, tricyclo, Spiro, or dispiro skeleton. Among them, a radiation-curable compound having a structure comprising plural rings which share atoms, for example, a radiation-curable compound having a skeleton such as a bicyclo, tricyclo, spiro, or dispiro skeleton, is preferable. Such a radiation-curable compound has a higher glass transition temperature than those of aliphatic compounds and therefore hardly cause adhesion troubles in steps after the application of the undercoat layer. The compound having an alicyclic skeleton such as a cyclohexane ring, bicyclo, tricyclo or spiro less shrinks by cure. Such a compound can therefore achieve high adhesion to the support and can produce excellent running durability.

Among radiation-curable compounds having an alicyclic ring structure, a compound having two or more radiation-curable functional groups in one molecule is preferable. Among others, dimethyloltricyclodecane diacrylate, dimethylolbicyclooctane diacrylate, and dimethylolspirooctane diacrylate are preferable. Dimethyloltricyclodecane diacrylate is particularly preferable. Specific examples of commercially available compounds include KAYARAD R-684 (manufactured by Nippon Kayaku Co., Ltd.), Light Acrylate DCP-A (manufactured by Kyoeisha Chemical Co., Ltd.), and LUMICURE DCA-200 (Dainippon Ink And Chemicals, Inc.).

Preferably, the radiation-curable compound has a molecular weight of 200 to 1000, more preferably 200 to 500, and has viscosity of 5 to 200 mPa·s, more preferably 5 to 100 mPa·s, at 25° C.

In the undercoat layer of the present embodiment, plural radiation-curable compounds may be used in combination.

It is preferred that the radiation-curable compound should be dissolved in a solvent for use. Preferably, an application solution for an undercoat layer has viscosity of 5 to 200 mPa·s. For example, methyl ethyl ketone (MEK), cyclohexanone, methanol, ethanol, or toluene is preferable as a solvent for the application solution for an undercoat layer.

The application solution for an undercoat layer is applied onto the support and dried. Then, the radiation-curable compound contained therein is cured by radiation exposure. Electron beams or ultraviolet rays can be used as radiation used in the present embodiment, as described above. Electron beams are preferably used from the viewpoint of eliminating the need of a polymerization initiator. When ultraviolet rays are used, a photopolymerization initiator must be added to the application solution for an undercoat layer.

When electron beams are used, an electron beam accelerator operated in a scanning, double scanning, or curtain beam manner can be used. A relative inexpensive high-power electron beam accelerator operated in a curtain beam manner is preferable. An acceleration voltage for electron beams is usually 30 to 1000 kV, preferably 50 to 300 kV. An absorbed dose thereof is usually 0.5 to 20 Mrad, preferably 2 to 10 Mrad. Electron beams with an acceleration voltage less than 30 kV produces insufficient energy transmission. Electron beams with an acceleration voltage exceeding 300 kV reduces the efficiency of energy used in the polymerization of the radiation-curable compound and is therefore uneconomical.

For example, a low pressure mercury lamp, high pressure mercury lamp, extra-high pressure mercury lamp, chemical lamp, or metal halide lamp can be used as a light source of ultraviolet rays. A high pressure mercury lamp having favorable irradiation efficiency is preferably used. A photo-radical polymerization initiator can be used as a photopolymerization initiator used for curing the radiation-curable compound by ultraviolet rays. For example, an initiator described in “Experimental Polymer Science, New Edition, Vol. 2, Part 6 Photopolymerization/Radiation Polymerization” (1995, published by Kyoritsu Shuppan Co., Ltd., edited by The Society of Polymer Science, Japan) can be used as a photo-radical polymerization initiator. Specific examples thereof include acetophenone, benzophenone, anthraquinone, benzoin ethyl ether, benzyl methyl ketal, benzyl ethyl ketal, benzoin isobutyl ketone, hydroxydimethylphenyl ketone, 1-hydroxycyclohexylphenyl ketone, and 2,2-diethoxyacetophenone. The mixing ratio of the photopolymerization initiator is usually 0.5 to 20 parts by mass, preferably 2 to 15 parts by mass, more preferably 3 to 10 parts by mass, with respect to 100 parts by mass of the radiation-curable compound.

Techniques known in the art described in, for example, “UV/EB Curing Technology” (published by Sogo Gijyutsu Center) or “Applied Technology of Low-Energy Electron Beam Irradiation” (2000, published by CMC Publishing Co., Ltd.) can be used for a radiation curing apparatus or a method for curing by radiation exposure.

It is preferred that an atmosphere in which the curable compound in the undercoat layer is cured by radiation exposure should contain an oxygen concentration of 1000 ppm or lower. A higher oxygen concentration inhibits the crosslinking or polymerization reaction of the curable compound in the vicinity of the surface of the undercoat layer. This oxygen concentration is preferably 500 ppm or lower, more preferably 200 ppm or lower, particularly preferably 50 ppm or lower. It is preferred that an approach for substituting excessive oxygen by nitrogen (nitrogen purge) should be used for setting this oxygen concentration in the atmosphere to 1000 ppm or lower.

It is preferred that the radiation-curable compound in the undercoat layer should be cured such that the undercoat layer is not dissolved in an application solvent used for preparing the non-magnetic layer or the magnetic layer constructed thereon. It is further preferred that the radiation-curable compound in the undercoat layer should be cured such that components in the undercoat layer migrate in as low amounts as possible in an application solvent used for the non-magnetic layer or the magnetic layer. The migration of components in large amounts may deteriorate the surface nature of the non-magnetic layer or the magnetic layer. Moreover, the deposition of components in the undercoat layer onto the surface of the magnetic layer easily makes a magnetic head dirty, causing errors in information input/output.

Preferably, the radiation-curable compound is cured such that 10% by mass or less, more preferably 6% by mass or less, even more preferably 4% by mass or less, particularly preferably 3% by mass or less, most preferably 0% by mass of components with respect to the undercoat layer migrate into the non-magnetic layer or the magnetic layer.

A lower volume shrinkage of the undercoat layer after the cure of the radiation-curable compound compared to before the cure is more preferable. In the present embodiment, the volume shrinkage is preferably 20% or less, more preferably 15% or less, even more preferably 12% or less, particularly preferably 10% or less. If the volume shrinkage of the undercoat layer exceeds 20%, cupping which is convex on the side having the magnetic layer is difficult to form in the magnetic recording medium.

Preferably, the undercoat layer has a film thickness of 2.0 μm or smaller, more preferably 0.05 to 1.0 μm, even more preferably 0.1 to 0.7 μm, particularly preferably 0.2 to 0.5 μm. If the film thickness of the undercoat layer is thicker than 2.0 μm, the support on which the undercoat layer has been applied may have poor handleability.

On the other hand, if the film thickness of the undercoat layer is thinner than 0.05 μm, the surface nature of the non-magnetic support more largely influences the surface nature of the magnetic layer.

The glass transition temperature Tg of the undercoat layer after the cure of the radiation-curable compound is preferably 40 to 150° C., more preferably 60 to 130° C. If the glass transition temperature Tg of the undercoat layer is lower than 40° C., the support on which the undercoat layer has been applied has poor handleability. If the glass transition temperature Tg of the undercoat layer exceeds 1 50° C., the undercoat layer may become fragile.

An undercoat layer containing particles is more likely to form protrusions on the surface of the magnetic layer. Preferably, the undercoat layer of the present embodiment is therefore substantially free from particles comprising an inorganic or organic compound.

### (Magnetic Layer)

In the magnetic recording medium of the present embodiment, examples of ferromagnetic powders contained in the magnetic layer can include hexagonal ferrite powders and ferromagnetic metal powders.

Examples of the hexagonal ferrite used in the present embodiment include each substitution product of barium ferrite, strontium ferrite, lead ferrite, and calcium ferrite, and a Co substitution product. Specific examples thereof include magnetoplumbite-type barium ferrite and strontium ferrite, magnetoplumbite-type ferrite having the particle surface coated with spinel, and magnetoplumbite-type barium ferrite and strontium ferrite partially containing a spinel phase. In addition, this compound may contain, in addition to the predetermined atoms contained therein, atoms such as Al, Si, S, Sc, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B, Ge, and Nb. In general, a compound supplemented with an element such as Co—Zn, Co—Ti, Co—Ti—Zr, Co—Ti—Zn, Ni—T—Zn, Nb—Zn—Co, Sb—Zn—Co, or Nb-Zn can be used. The compound may also contain specific impurities according to raw materials or a production method.

A particle size thereof is preferably 10 to 100 nm, more preferably 10 to 60 nm, particularly preferably 10 to 50 nm, in terms of the diameter of a hexagonal plate. Particularly, a magnetic recording medium regenerated in an MR head for a higher track density requires reducing a noise. It is therefore preferred that a plate diameter thereof should be 40 nm or smaller. If the plate diameter is smaller than 10 nm, stable magnetization is not expected due to thermal fluctuation. A plate diameter exceeding 100 nm increases a noise and is not suitable for high-density magnetic recording. A plate ratio (plate diameter/plate thickness) is preferably 1 to 15, more preferably 1 to 7. If the plate ratio is smaller than this range, packing density in the magnetic layer is enhanced and thus preferable but sufficient orientation is difficult to obtain. If the plate ratio is larger than 15, a noise is increased due to stacking between particles. In this particle size range, a specific surface area according to the BET method is 10 to 100 m²/g. This specific surface area is generally consistent with an arithmetically calculated value based on the plate diameter and plate thickness of the particle. Narrower distributions of the plate diameter and plate thickness of the particle are usually more preferable. These distributions are difficult to convert into numbers. However, 500 particles can be measured at random using the TEM image of the particles to achieve comparison. These distributions are not normal distributions in most cases. The distributions are represented in standard deviation σ to mean size through calculation: σ/mean size=0.1 to 2.0. To narrow down the particle size distribution, particle-producing reaction systems are equalized as much as possible, while treatment for improving distribution may be applied to the produced particles. For example, a method for selectively dissolving ultra-fine particles in an acid solution is also known.

In general, hexagonal ferrite powders with coercive force Hc on the order of 500 Oe to 5000 Oe (40 to 398 kA/m) can be prepared. Higher coercive force Hc is more advantageous for high-density recording. However, the coercive force Hc is limited by the ability of a recording head. The coercive force Hc of the hexagonal ferrite used in the present embodiment is preferably approximately 2000 to 4000 Oe (160 to 320 kA/m), more preferably 2200 to 3500 Oe (176 to 280 kA/m). When the saturation magnetization of a head exceeds 1.4 tesla, it is preferred that the coercive force Hc should be set to 2200 Oe (176 kA/m) or more. The coercive force Hc can be controlled by factors such as a particle size (plate diameter/plate thickness), the types and amounts of elements contained therein, a substitution site of the element, and conditions for particle-producing reaction. Saturation magnetization as is preferably 40 to 80 A·m²/kg. Higher saturation magnetization σs is more preferable. However, the saturation magnetization σs is decreased more for finer particles. A well known approach for improving saturation magnetization σs involves, for example, combining spinel ferrite with magnetoplumbite ferrite or appropriately selecting the types and amounts of elements contained therein. Alternatively, W-type hexagonal ferrite can be used. To disperse hexagonal ferrite, the hexagonal ferrite powders may be surface-treated with a substance appropriate for a dispersion medium or the polymer. Examples of a surface treatment agent used in this treatment include inorganic or organic compounds, typically including oxides or hydroxides of Si, Al, or P., various silane coupling agents, and various titanium coupling agents. The amount of the surface treatment agent added can be set to 0.1 to 10% by mass with respect to the hexagonal ferrite powders. The pH of the hexagonal ferrite powders is also important for dispersion and is usually adjusted to approximately 4 to 12. The optimal value of pH is selected, though differing depending on a dispersion medium or the polymer, from approximately 6 to 11 from the viewpoint of the chemical stability and storage properties of the medium. Moisture contained in the hexagonal ferrite powders also influences dispersion. The optimal value of a moisture content is usually selected, though differing depending on a dispersion medium or the polymer, from 0.01 to 2.0% by mass. Examples of a method for producing hexagonal ferrite in the present embodiment include but not particularly limited to: (1) a glass crystallization method which comprises: mixing a metal oxide for the substitution of barium oxide/iron oxide/iron with a glass-forming substance such as boron oxide to form the desired ferrite composition; then melting the mixture; rapidly cooling the mixture to prepare an amorphous mixture; and subsequently heating the amorphous mixture again, followed by washing and pulverization to obtain barium ferrite crystalline powders; (2) a hydrothermal reaction method which comprises: neutralizing a metal salt solution having barium ferrite composition with alkali; and after the removal of by-products, heating the resulting solution in a liquid phase at 100° C. or higher, followed by washing, drying, and pulverization to obtain barium ferrite crystalline powders; and (3) a coprecipitation method which comprises: neutralizing a metal salt solution having barium ferrite composition with alkali; after the removal of by-products, drying the solution; and then treating the resulting product at 1100° C. or lower, followed by pulverization to obtain barium ferrite crystalline powders.

The ferromagnetic metal powders used in the magnetic layer are not particularly limited and are preferably ferromagnetic metal powders mainly composed of α-Fe. These ferromagnetic metal powders may contain, in addition to the predetermined atoms, atoms such as Al, Si, S, Sc, Ca, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, and B. Particularly, the ferromagnetic metal powders contains preferably at least one of Al, Si, Ca, Y, Ba, La, Nd, Co, Ni, and B, more preferably at least one of Co, Y, and Al, in addition to α-Fe. The content of Co is preferably 0% by atom or more and 40% by atom or less, more preferably 15% by atom or more and 35% by atom or less, even more preferably 20% by atom or more 35% by atom or less, with respect to Fe. The content of Y is preferably 1.5% by atom or more and 12% by atom or less, more preferably 3% by atom or more and 10% by atom or less, particularly preferably 4% by atom or more 9% by atom or less. The content of Al is preferably 1.5% by atom or more and 12% by atom or less, more preferably 3% by atom or more and 10% by atom or less, even more preferably 4% by atom or more and 9% by atom or less.

These ferromagnetic metal powders may be treated in advance before dispersion with a dispersing agent, a lubricant, a surfactant, an anti-static agent, and the like described later. Specific examples of the treatment are described in, for example, Japanese Examined Application Publication Nos. 44-14090, 45-18372, 47-22062, 47-22513, 46-28466, 46-38755, 47-4286, 47-12422, 47-17284, 47-18509, 47-18573, 39-10307, and 46-39639, U.S. Patent Nos. 3026215, 3031341, 3100194, 3242005, and 3389014.

The ferromagnetic metal powders may contain a small amount of a hydroxide or oxide. Ferromagnetic metal powders obtained by production methods known in the art can be used. Examples of the production methods include: a method which comprises reducing a composite organic acid salt (mainly, oxalate) using reducing gas such as hydrogen; a method which comprises reducing iron oxide using reducing gas such as hydrogen to obtain Fe or Fe-Co particles; a method which comprises thermally decomposing a metal carbonyl compound; a method which comprises adding a reducing agent such as sodium borohydride, hypophosphite, or hydrazine to an aqueous solution of a ferromagnetic metal to perform reduction; and a method which comprises evaporating a metal in inert gas under a low pressure to obtain fine powders. The ferromagnetic metal powders thus obtained may also be subjected to gradual oxidizing method known in the art, for example, any of a method which comprises immersing the powders in an organic solvent, followed by drying, a method which comprises immersing the powders in an organic solvent and then forming an oxide film on the surface by the supply of oxygen-containing gas, followed by drying, and a method which comprises forming an oxide film on the surface by adjusting the partial pressure of oxygen gas and inert gas without using an organic solvent.

Preferably, the ferromagnetic metal powders used in the magnetic layer have a specific surface area of 45 to 100 m²/g, more preferably 50 to 80 m²/g, according to the BET method. If the specific surface area is 45 m²/g or more, a noise is low. If the specific surface area is 100 m²/g or less, favorable surface nature can be obtained. Preferably, the ferromagnetic metal powders have: a crystallite size of 80 to 180 Å, more preferably 100 to 180 Å, even more preferably 110 to 175 Å; a longer axis diameter of 0.01 μm or larger and 0.15 μm or smaller, more preferably 0.02 μm or larger and 0.15 μm or smaller, even more preferably 0.03 μm or larger and 0.12 μm or smaller; an acicular ratio of 3 or more and 15 or less, more preferably 5 or more and 12 or less; σs of 90 to 180 A·m²/kg, more preferably 100 to 150 A·m²/kg, even more preferably 105 to 140 A·m²/kg; and coercive force of 2000 to 3500 Oe (160 to 280 kA/m), more preferably 2200 to 3000 Oe (176 to 240 kA/m).

Preferably, the ferromagnetic metal powders have a moisture content of 0.01 to 2%. It is preferred that the moisture content of the ferromagnetic metal powders should be optimized according to the type of a binder. It is also preferred that the pH of the ferromagnetic metal powders should be optimized according to the combination with a binder used. A pH range thereof can be set to 4 to 12, preferably 6 to 10. The ferromagnetic metal powders may be surface-treated, if necessary, with Al, Si, P, or an oxide thereof. The amount of this surface treatment can be 0.1 to 10% with respect to the ferromagnetic metal powders. Such surface-treated ferromagnetic metal powders adsorb thereon a lubricant such as fatty acid in an amount of 100 mg/m² or less and are therefore preferable. The ferromagnetic metal powders sometimes contain soluble inorganic ions such as Na, Ca, Fe, Ni, and Sr. It is preferred that the ferromagnetic metal powders should essentially be free from these inorganic ions. However, 200 ppm or smaller of the inorganic ions less influence the properties of the ferromagnetic metal powders. It is preferred that the ferromagnetic metal powders used in the present embodiment should have fewer holes. The rate of holes is preferably 20% by capacity or less, more preferably 5% by capacity or less. The ferromagnetic metal powders may be in any shape that satisfies the particle size properties, for example, a needle-like, grain-like, or spindle-like shape. Smaller SFD of the ferromagnetic metal powders themselves is more preferable. The SFD is preferably 0.8 or less. It is preferred that the distribution of coercive force Hc of the ferromagnetic metal powders should be small. If the SFD of the ferromagnetic metal powders is 0.8 or less, favorable electromagnetic conversion characteristics, high output, sharp magnetization inversion, and reduced peak shift are achieved. Therefore, such SFD is preferable for high-density digital magnetic recording. A method for obtaining a small distribution of coercive force Hc of the ferromagnetic metal powders involves, for example, improving the particle size distribution of goethite in the ferromagnetic metal powders or preventing sintering.

The binder in the magnetic layer is preferably a polyurethane-based resin, a polyester-based resin, or cellulose acetate in terms of the suitable fine dispersibility or suitable durability (suitable temperature-humidity environment) of the ferromagnetic powder particles, more preferably a polyurethane-based resin or a polyester-based resin, most preferably a polyurethane-based resin. The structure of the polyurethane-based resin is not particularly limited. Those known in the art such as polyester polyurethane, polyether polyurethane, polyether polyester polyurethane, polycarbonate polyurethane, polyester polycarbonate polyurethane, polycaprolactone polyurethane can be used.

It is preferred that the binder should comprise a resin having a mass-average molecular weight (Mw) of 120,000 or larger as a constituent component. When the magnetic recording medium is prepared by the successive multilayer coating method preferable for the present embodiment, magnetic field orientation treatment after the application of an application solution for a magnetic layer may cause the aggregation of the ferromagnetic powder particles (oriented aggregation). This oriented aggregation is particularly prominently caused in the use of an application solution for a magnetic layer with a low concentration for forming a magnetic layer having a thin film thickness. This is because ferromagnetic powder particles in such an application solution with a lower concentration are moved more easily by magnetic force in orientation treatment and oriented-aggregated more easily.

The oriented aggregation can be reduced or prevented by using, as a binder in the magnetic layer, a binder component comprising, as a constituent component, a resin that has a molecular weight larger than that of a resin conventionally used as a binder in a magnetic recording medium and has a mass-average molecular weight (Mw) of 120,000 or larger.

The resin having such a molecular weight is capable of being highly adsorbed onto the ferromagnetic powder particles. Therefore, the use of such a resin as a component in an application solution for a magnetic layer can increase the amount of the binder adsorbed onto the ferromagnetic powder particles in the application solution for a magnetic layer. The thus-increased amount of the binder adsorbed thereonto increases the steric repulsion between the ferromagnetic powder particles in the application solution for a magnetic layer. Thus, the oriented aggregation of the ferromagnetic powder particles during orientation treatment can be suppressed. Plural resins having a mass-average molecular weight of 120,000 or larger may be used in combination in the binder.

The mass-average molecular weight of the binder can be confirmed, for example, by gel permeation chromatography (GPC) analysis.

On the other hand, the mass-average molecular weight of the resin is preferably 500,000 or smaller, more preferably 120,000 to 300,000, particularly preferably 150,000 to 250,000, in consideration of solubility or ease of synthesis.

It is preferred that the magnetic layer should contain 2.5% by mass or more of the resin having a mass-average molecular weight (Mw) of 120,000 or larger with respect to the ferromagnetic powders. Specifically, it is preferred that the magnetic recording medium of the present embodiment should be formed using an application solution for a magnetic layer containing 2.5% by mass or more of the resin with respect to the ferromagnetic powders. The application solution for a magnetic layer containing 2.5% by mass or more of the resin with respect to the ferromagnetic powders can increase the amount of the binder adsorbed onto the ferromagnetic powders and can effectively suppress oriented aggregation. The amount of the resin in the magnetic layer is preferably 4 to 40% by mass, more preferably 5 to 30% by mass, particularly preferably 5 to 25% by mass, with respect to the ferromagnetic powders.

Preferably, such a resin has: a glass transition temperature of −50 to 150° C., more preferably 0 to 100° C., even more preferably 30 to 90° C.; breaking elongation of 100 to 2000%; breaking stress of 0.05 to 10 kg/mm² (0.49 to 98 MPa); and a yield point of 0.05 to 10 kg/mm² (0.49 to 98 MPa). The resin can be synthesized by methods known in the art or may be obtained as a commercially available product.

The binder component can consist of the resin. Specifically, the binder component may be the resin itself. Alternatively, the binder component may be a reaction product of the resin with a compound having a heat-curable functional group. It is preferred that the magnetic recording medium of the present embodiment should be formed by applying an application solution for a magnetic layer onto a non-magnetic layer formed on a non-magnetic support and drying the application solution for a magnetic layer. When the resin is added to the application solution for a magnetic layer without adding thereto the compound having a heat-curable functional group to form the magnetic layer, the obtained magnetic recording medium comprises the resin itself as the binder component. On the other hand, when the compound having a heat-curable functional group was added together with the resin to the application solution for a magnetic layer, heating (calender treatment, heat treatment, etc) after application promotes cure reaction (crosslinking reaction). The obtained magnetic recording medium therefore comprises a reaction product of the resin with the compound having a heat-curable functional group as the binder component. When a resin component other than the resin and the compound having a curable functional group is also added, as described later, to the application solution for a magnetic layer, the reaction product may contain a copolymer of the resin, the compound having a heat-curable functional group, and the additional resin component.

It is preferred that a compound containing an isocyanate group as a heat-curable functional group should be used as the compound having a heat-curable functional group. Among others, polyisocyanates are preferable as the compound. For example, isocyanates (e.g., tolylene diisocyanate, 4,4′-diphenylmethane diisocyanate, hexamethylene diisocyanate, xylylene diisocyanate, naphthylene-1,5-diisocyanate, o-toluidine diisocyanate, isophorone diisocyanate, and triphenylmethane triisocyanate), products of these isocyanates with polyalcohol, and polyisocyanates produced by the condensation of isocyanates can be used.

Examples of commercially available products of these isocyanates include trade names Coronate L, Coronate HL, Coronate 2030, Coronate 2031, Millionate MR, and Millionate MTL manufactured by Nippon Polyurethane Industry Co., Ltd., Takenate D-102, Takenate D-110N, Takenate D-200, and Takenate D-202 manufactured by Takeda Pharmaceutical Co., Ltd., and Desmodule L, Desmodule IL, Desmodule N, and Desmodule HL manufactured by Sumitomo Bayer Co., Ltd. These isocyanates can be used alone or can also be used in combination of two or more of them using difference in cure reactivity.

The binder can also contain an additional binder component in addition to the binder component described above. Examples of the additional binder compound that can be used in combination with the binder component can include thermoplastic resins, heat-curable resins, reactive resins, and mixtures thereof conventionally known in the art. For example, the thermoplastic resins used in combination therewith have a glass transition temperature of preferably −100 to 200° C., more preferably −50 to 150° C.

Specific examples of the thermoplastic resins that can be used in combination therewith include: a polymer or copolymer containing a constituent unit such as vinyl chloride, vinyl acetate, vinyl alcohol, maleic acid, acrylic acid, acrylic acid ester, vinylidene chloride, acrylonitrile, methacrylic acid, methacrylic acid ester, styrene, butadiene, ethylene, vinyl butyral, vinyl acetal, or vinyl ether; polyurethane-based resins; various rubber-based resins; and cellulose ester.

Alternatively, examples of the heat-curable resins or reactive resins that can be used in combination therewith include phenol resins, epoxy resins, polyurethane cured resins, urea resins, melamine resins, alkyd resins, acrylic reactive resins, formaldehyde resins, silicone resins, epoxy-polyamide resins, mixtures of polyester resins with isocyanate prepolymers, mixtures of polyester polyol and polyisocyanate, and mixtures of polyurethane with polyisocyanate. These resins are described in detail in “Plastic Handbook” published by Asakura Publishing Co., Ltd. Moreover, an electron beam-curable resin known in the art can also be used in each layer. These examples and a method for producing the same are described in detail in Japanese Patent Application Laid-Open No. 62-256219.

These resins may be used alone or in combination. Preferable examples thereof include: the combination of a polyurethane-based resin with at least one selected from vinyl chloride-based resins, a vinyl chloride-vinyl acetate copolymer, a vinyl chloride-vinyl acetate-vinyl alcohol copolymer, and a vinyl chloride-vinyl acetate-maleic anhydride copolymer; and the combination of polyisocyanate with any of them. A vinyl chloride-based resin is particularly preferable. The use of the vinyl chloride-based resin in combination with the resin component can further enhance the dispersibility of the ferromagnetic powders and is effective for improving electromagnetic conversion characteristics and improving head dirt.

To obtain more excellent dispersibility and durability for all the binder components that can be used in the magnetic layer, at least one or more polar groups selected from —COOM, —SO₃M, —OSO₃M, —P═O(OM)₂, —O—P═O(OM)₂ (in these moieties, “M” represents a hydrogen atom or alkali metal base), OH, NR₂, N⁺R₃ (“R” represents a hydrocarbon group), an epoxy group, SH, and CN can be introduced therein through copolymerization or addition reaction, if necessary, and then used. The amount of such a polar group is, for example, 10⁻¹ to 10⁻⁸ mol/g, preferably 10⁻² to 10⁻⁶ mol/g.

Specific examples of the binder component include VAGH, VYHH, VMCH, VAGF, VAGD, VROH, VYES, VYNC, VMCC, XYHL, XYSG, PKHH, PKHJ, PKHC, and PKFE manufactured by Union Carbide Corp., MPR-TA, MPR-TA5, MPR-TAL, MPR-TSN, MPR-TMF, MPR-TS, MPR-TM, and MPR-TAO manufactured by Nisshin Chemical Industry Co., Ltd., 1000W, DX80, DX81, DX82, DX83, and 100FD manufactured by Denki Kagaku Co., Ltd., MR-104, MR-105, MR110, MR100, MR555, 400X-110A manufactured by Zeon Corp., Nippollan N2301, N2302, and N2304 manufactured by Nippon Polyurethane Industry Co., Ltd., Pandex T-5105, T-R3080, and T-5201, Bumock D-400 and D-210-80, and Crisvon 6109 and 7209 manufactured by Dainippon Ink And Chemicals, Inc., Vylon UR8200, UR8300, UR-8700, RV530, and RV280 manufactured by TOYOBO Co., Ltd., Daiferamine 4020, 5020, 5100, 5300, 9020, 9022, and 7020 manufactured by Dainichiseika Color & Chemicals Mfg. Co., Ltd, MX5004 manufactured by Mitsubishi Chemical Corp., Sunprene SP-150 manufactured by Sanyo Chemical Industries, Ltd., and Saran F310 and F210 manufactured by Asahi Chemical Industry Co., Ltd.

In the magnetic layer containing the compound having a heat-curable functional group, the crosslinking reaction between the resin and the compound is promoted by the heating of the magnetic layer. As a result, the obtained magnetic layer comprises a reaction product of the resin with the compound having a heat-curable functional group. This magnetic layer has coating strength higher than that of the magnetic layer containing the resin itself and can therefore produce a magnetic recording medium with higher durability. Preferably, the content of the compound having a heat-curable functional group in the magnetic layer is set to 5 to 40% by mass, more preferably 10 to 30% by mass, particularly preferably 15 to 25% by mass, with the total amount of the binders contained in the magnetic layer.

The magnetic layer can contain additional binder components (compound having heat-curable functional group, resin component, etc.) in addition to the resin, as described above. The details thereof are described above. The amount of the resin having a mass-average molecular weight (Mw) of 120,000 or larger is preferably 10 to 80% by mass, more preferably 20 to 60% by mass, most preferably 20 to 40% by mass, with respect to the total amount of the binder components, both for preventing oriented aggregation and for securing excellent electromagnetic conversion characteristics by the addition of this resin. The content of the binder components other than the resin in the magnetic layer is preferably 2.5% by mass or larger, more preferably 4 to 40% by mass, even more preferably 5 to 30% by mass, particularly preferably 5 to 25% by mass, with respect to the ferromagnetic powders, for obtaining effects brought about by the addition of these binder components.

Preferably, the magnetic layer in the magnetic recording medium of the present embodiment has a thickness of, for example 10 to 300 nm. In the present embodiment, a relatively thin magnetic layer having the thickness range is formed by successive multilayer coating using the resin having a mass-average molecular weight (Mw) of 120,000 or larger in the magnetic layer. In this case, oriented aggregation can be suppressed. As a result, a magnetic recording medium having high electromagnetic conversion characteristics can be obtained. The thickness of the magnetic layer is more preferably 30 to 150 nm, even more preferably 40 to 100 nm.

The surface of the magnetic layer having a lower center line average surface roughness (Ra) is more preferable. The surface roughness of the magnetic layer can be evaluated using an atomic force microscope (AFM).

Preferably, the magnetic layer of the present embodiment has a center line average surface roughness (Ra) of 10.0 nm or less, more preferably 1.0 to 10.0 nm, even more preferably 2.0 to 7.0 nm, particularly preferably 2.5 to 5.0 nm. Preferably, the surface of the magnetic layer has fine protrusions having a height of 10 to 20 nm at a rate of 1 to 500 pieces/100 μm², more preferably 3 to 250 pieces/100 μm², even more preferably 5 to 150 pieces/100 μm², particularly preferably 5 to 100 pieces/100 μm².

The center line average surface roughness (Ra) of the magnetic layer is influenced by factors such as the influence of surface nature of the non-magnetic support on the surface of the magnetic layer, the dispersibility of the ferromagnetic powders in the magnetic layer, and the particle size and amount of an abrasive or carbon black added to the magnetic layer.

The center line average surface roughness (Ra) of the magnetic layer (magnetic recording medium) and the number of fine protrusions on the surface thereof can be reduced, for example, by: reducing, by the undercoat layer of the present embodiment, the influence of surface nature of the non-magnetic support on other layers; enhancing the fine dispersibility of the ferromagnetic powders; reducing the particle size of an abrasive or carbon black; or reducing the amount of an abrasive or carbon black added.

Alternatively, the center line average surface roughness (Ra) of the magnetic layer (magnetic recording medium) and the number of fine protrusions on the surface thereof can be reduced by calender treatment steps and can be reduced, for example, by: increasing a linear pressure; making a pressure loading time longer; or raising a treatment temperature.

### (Non-Magnetic Layer)

The non-magnetic layer used in the magnetic recording medium of the present embodiment may comprise at least non-magnetic powders and a binder. Hereinafter, such a non-magnetic layer will be described in detail.

The non-magnetic layer is not particularly limited as long as it is substantially non-magnetic. The non-magnetic layer can also contain magnetic powders within a range that is substantially non-magnetic. The phrase “substantially non-magnetic” means that the magnetism of the non-magnetic layer is permitted within a range that substantially causes no reduction in the electromagnetic conversion characteristics of the magnetic layer. The phrase “substantially non-magnetic” refers to, for example, a residual magnetic flux density of 0.01 T or less or coercive force of 7.96 kA/m or less (100 Oe or less), preferably, the absence of a residual magnetic flux density and coercive force.

The nonmagnetic powders used in the non-magnetic layer can be selected from, for example, inorganic compounds such as metal oxides, metal carbonate, metal sulfate, metal nitrides, metal carbides, and metal sulfides. For example, α-alumina having an α component proportion of 90% or higher, β-alumina, γ-alumina, θ-alumina, silicon carbide, chromium oxide, cerium oxide, α-iron oxide, hematite, goethite, corundum, silicon nitride, titanium carbide, titanium oxide, silicon dioxide, tin oxide, magnesium oxide, tungsten oxide, zirconium oxide, boron nitride, zinc oxide, calcium carbonate, calcium sulfate, barium sulfate, and molybdenum disulfide can be used alone or in combination as inorganic compounds. Particularly, titanium dioxide, zinc oxide, iron oxide, and barium sulfate are preferable in terms of their small particle size distributions and many devices which functionalize them. Titanium dioxide and cc-iron oxide are more preferable. Preferably, these non-magnetic powders have a particle size of 0.005 to 2 μm. If necessary, non-magnetic powders having different particle sizes are combined. Even non-magnetic powders having a single particle size can have similar effects by making its particle size distribution wider. The particle size of the non-magnetic powders is particularly preferably 0.01 to 0.2 μm. Particularly, when the non-magnetic powders are granular metal oxides, it is preferred that the non-magnetic powders should have an average particle size of 0.08 μm or smaller. When the non-magnetic powders are needle-like metal oxides, it is preferred that the non-magnetic powders should have a longer axis diameter of 0.3 μm or smaller, more preferably 0.2 μm or smaller. Preferably, the non-magnetic powders have: a tap density of 0.05 to 2 g/ml, more preferably 0.2 to 1.5 g/ml: a moisture content of 0.1 to 5% by mass, more preferably 0.2 to 3% by mass, even more preferably 0.3 to 1.5% by mass; and pH of 2 to 11, particularly preferably between 5.5 and 10.

Preferably, the non-magnetic powders have: a specific surface area of 1 to 100 m²/g, more preferably 5 to 80 m²/g, even more preferably 10 to 70 m²/g; a crystallite size of 0.004 μm to 1 μm, more preferably 0.04 μm to 0.1 μm; a DBP (dibutyl phthalate) oil absorption of 5 to 100 ml/100 g, more preferably 10 to 80 ml/100 g, even more preferably 20 to 60 ml/100 g; and a specific gravity of 1 to 12, more preferably 3 to 6. The non-magnetic powders may be in any shape, for example, a needle-like, spherical, polyhedral, or plate-like shape. Preferably, the non-magnetic powders have: Mohs hardness of 4 or more and 10 or less; an amount of SA (stearic acid) adsorption of 1 to 20 μmol/m², more preferably 2 to 15 μmol/m², even more preferably 3 to 8 μmol/m²; and pH between 3 and 6. It is preferred that these non-magnetic powders should be surface-treated to allow Al₂O₃, SiO₂, TiO₂, ZrO₂, SnO₂, Sb₂O₃, ZnO, or Y₂O₃ to exist on the surface. Particularly, Al₂O₃, SiO₂, TiO₂, and ZrO₂ are preferable in terms of dispersibility. Al₂O₃, SiO₂, and ZrO₂ are more preferable. These substances may be used in combination or can be used alone. Depending on the purpose, a coprecipitated surface-treated layer may be used, or a method may be adopted which comprises performing surface treatment first with alumina and then with silica, or vice versa. The surface-treated layer may be a porous layer depending on the purpose and is, generally preferably, uniform and dense.

Specific examples of the non-magnetic powders include Nanotite manufactured by Showa Denko K.K., HIT-100 and ZA-G1 manufactured by Sumitomo Chemical Co., Ltd., α-hematite DPN-250, DPN-250BX, DPN-245, DPN-270BX, DPN-500BX, DBN-SA1, and DBN-SA3 manufactured by Toda Kogyo Corp., titanium oxide TTO-51B, TTO-55A, TTO-55B, TTO-55C, TTO-55S, and TTO-55D, SN-100, and α-hematite E270, E271, E300, and E303 manufactured by Ishihara Sangyo Co., Ltd., titanium oxide STT-4D, STT-30D, STT-30, and STT-65C, and α-hematite α-40 manufactured by Titan Kogyo K.K., MT-100S, MT-100T, MT-150W, MT-500B, MT-600B, MT-100F, and MT-500HD manufactured by Tayca Corp., FINEX-25, BF-1, BF-10, BF-20, and ST-M manufactured by Sakai Chemical Industry Co., Ltd., DEFIC-Y and DEFIC-R manufactured by Dowa Mining Co., Ltd., AS2BM and TiO₂ P25 manufactured by Nippon Aerosil Co., Ltd., 100A and 500A manufactured by Ube Industries Co., Ltd., and sintered products thereof. Particularly preferable non-magnetic powders are titanium dioxide and α-iron oxide.

Organic matter powders can also be added to the non-magnetic layer depending on the purpose. Examples thereof include acrylic styrene-based resin powders, benzoguanamine resin powders, melamine-based resin powders, and phthalocyanine-based pigments. Polyolefin-based resin powders, polyester-based resin powders, polyamide-based resin powders, polyimide-based resin powders, and a polyethylene fluoride resin can also be used. Methods described in Japanese Patent Application Laid-Open Nos. 62-18564 and 60-255827 can be used as production methods thereof.

The thermoplastic resins, heat-plastic resins, reactive resins, or mixtures thereof described as the binder component that can be used in the magnetic layer can be used as a binder used in the non-magnetic layer. Preferably, the content of the binder in the non-magnetic layer is in the range of 5 to 50% by mass, more preferably 10 to 30% by mass, with respect to the non-magnetic powders. It is preferred that 5 to 30% by mass of a vinyl chloride-based resin, 2 to 20% by mass of a polyurethane resin, and 2 to 20% by mass of polyisocyanate should be used in combination. For example, when a trace amount of dechlorination causes head corrosion, only polyurethane or only the combination of polyurethane with isocyanate may be used as a binder. Polyurethane preferably used in the non-magnetic layer has: a glass transition temperature of −50 to 150° C., preferably 0 to 100° C., even more preferably 30 to 90° C.; breaking elongation of 100 to 2000%; breaking stress of 0.05 to 10 kg/mm² (0.49 to 98 MPa); and a yield point of 0.05 to 10 kg/mm² (0.49 to 98 MPa).

Of course, the amount of the binder added to the non-magnetic layer, the amount of a vinyl chloride-based resin, a polyurethane resin, polyisocyanate, or the other resin in the binder, the molecular weight of each resin, the amount of a polar group, or the physical properties of the resin may be changed as appropriate by applying thereto techniques known in the art. For example, to enhance a head touch, the amount of the binder in the non-magnetic layer can be increased to impart flexibility to the non-magnetic layer.

Examples of polyisocyanate that can be used in the non-magnetic layer can include those described above as the component in the magnetic layer.

### (Carbon Black)

In the magnetic recording medium of the present embodiment, the magnetic layer and/or the non-magnetic layer may contain carbon black. Examples of the carbon black that can be used can include furnace black for rubber, thermal black for rubber, carbon black for coloring, and acetylene black. Preferably, the carbon black has: a specific surface area of 5 to 500 m²/g; a DBP oil absorption of 10 to 400 ml/100 g; and an average particle size of 5 to 300 nm, preferably 10 to 250 nm, more preferably 20 to 200 nm. Preferably, the carbon black has: pH of2 to 10, a moisture content of 0.1 to 10%, and a tap density of 0.1 to 1 g/cc. Specific examples of the carbon black used in the present embodiment include BLACK PEARLS 2000, 1300, 1000, 900, 905, 800, and 700 and VULCAN XC-72 manufactured by Cabot Corp., #80, #60, #55, #50, and #35 manufactured by Asahi Carbon Co., Ltd., #2400B, #2300, #900, #1000, #30, #40, and #10B manufactured by Mitsubishi Chemical Corp., CONDUCTEX SC and RAVEN 150, 50, 40, 15, and RAVEN-MT-P manufactured by Columbia Carbon Co., Ltd., and Ketchenblack EC manufactured by Nippon E.C. Co., Ltd. The carbon black may be surface-treated with a dispersing agent or the like. Alternatively, the carbon black used may be grafted with a resin, or a portion of the surface of the carbon black may be treated with graphite. Alternatively, the carbon black may be dispersed in advance with a binder and then added to an application solution. These carbon blacks can be used alone or in combination. When the carbon black is used, it is preferred that the carbon black should be used in an amount of 0.1 to 30% by mass with respect to the amount of the ferromagnetic powders or the non-magnetic powders. The carbon black has functions such as anti-static effects on the magnetic layer, reduction in coefficient of friction (the imparting of lubricity), the imparting of light blocking effects, and improvement in film strength. The degrees of these effects differ depending on the type of the carbon black used. The mixing of the carbon black into the non-magnetic layer can also achieve effects known in the art, such as reduction in electrical surface resistance Rs, reduction in light transmission, and the acquisition of the desired micro-Vickers hardness. Moreover, the mixing of the carbon black into the non-magnetic layer can achieve the effect of storing a lubricant. Thus, the type, amount, or combination of the carbon black(s) used in the present embodiment is changed according to the characteristics required for the magnetic layer and the non-magnetic layer. As a result, of course, the carbon black(s) can be used properly depending on the purpose in consideration of characteristics such as a particle size, an oil absorption, conductivity, or pH and preferably optimized for each layer. In the present invention, for example, “Carbon Black Handbook” (edited by the Carbon Black Association) can be consulted for the carbon black that can be used in the magnetic layer and/or the non-magnetic layer.

### (Abrasive)

Materials known in the art that are mainly composed of α-alumina having an α component proportion of 90% or higher, β-alumina, silicon carbide, chromium oxide, cerium oxide, α-iron oxide, corundum, artificial diamond, silicon nitride, titanium carbide, titanium oxide, silicon dioxide, or boron nitride and have Mohs hardness of 6 or more can be used alone or in combination as an abrasive used in the present embodiment. Alternatively, a complex of these abrasives (an abrasive surface-treated with the other abrasive) may be used. These abrasives sometimes contain compounds or elements other than the main component and produce the same effects as long as the main component occupies 90% or more of the abrasive. Preferably, these abrasives have a particle size in the range of 0.01 to 2 μm, more preferably 0.05 to 1.0 μm, particularly preferably 0.05 to 0.5 μm. Particularly, a narrower particle size distribution of the abrasive is more preferable for enhancing electromagnetic conversion characteristics. Abrasives having different particle sizes are combined, if necessary, for improving durability. Even abrasives having a single particle size can have similar effects by making its particle size distribution wider. Preferably, the abrasive has a tap density of 0.3 to 2 g/cc, a moisture content of 0.1 to 5%, pH of 2 to 11, and a specific surface area of 1 to 30 m²/g. The abrasive used in the present embodiment may be in any shape, for example, a needle-like, spherical, or dice-like shape. An abrasive having a sharp edge in a portion of the shape is highly abradable and is therefore preferable. Specific examples of the abrasive include AKP-12, AKP-15, AKP-20, AKP-30, AKP-50, HIT-20, HIT-30, HIT-55, HIT-60, HIT-70, HIT-80, and HIT-100 manufactured by Sumitomo Chemical Co., Ltd., ERC-DBM, HP-DBM, and HPS-DBM manufactured by Reynolds International Inc., WA10000 manufactured by Fujimi Kenmazai K.K., UB20 manufactured by Uemura Kogyo K.K., G-5, Kromex U2, and Kromex U1 manufactured by Nippon Chemical Industrial Co., Ltd., TF100 and TF140 manufactured by Toda Kogyo Co., Ltd., β-Random Ultrafine manufactured by Ibiden Co., Ltd., and B-3 manufactured by Showa Mining Co., Ltd. These abrasives can also be added, if necessary, to the non-magnetic layer. The addition of the abrasives to the non-magnetic layer can control a surface shape or control the protruded state of the abrasives. It is preferred that the particle size or amount of these abrasive added to the magnetic layer or the non-magnetic layer should be set to the optimal value.

### (Additive)

In the present embodiment, additives having, for example, lubrication, antistatic, dispersing, and plasticizing effects, can be used in the undercoat layer, the magnetic layer, and the non-magnetic layer. Specific examples of the additives that can be used include molybdenum disulfide, tungsten disulfide, graphite, boron nitride, graphite fluoride, silicone oil, silicone having a polar group, fatty acid-modified silicone, fluorine-containing silicone, fluorine-containing alcohol, fluorine-containing ester, polyolefin, polyglycol, alkyl phosphate and alkali metal salts thereof, alkyl sulfate and alkali metal salts thereof, polyphenyl ether, phenylphosphonic acid, α-naphthylphosphoric acid, phenylphosphoric acid, diphenylphosphoric acid, p-ethylbenzenephosphonic acid, phenylphosphinic acid, aminoquinones, various silane coupling agents, titanium coupling agents, fluorine-containing alkyl sulfate and alkali metal salts thereof, monobasic fatty acids having 10 to 24 carbon atoms (which may contain an unsaturated bond or may be branched) and metal salts thereof (e.g., Li, Na, K, or Cu), mono-, di-, tri-, tetra-, penta-, or hexahydric alcohols having 12 to 22 carbon atoms (which may contain an unsaturated bond or may be branched), alkoxy alcohols having 12 to 22 carbon atoms, mono-, di-, or tri-fatty acid esters composed of a monobasic fatty acid having 10 to 24 carbon atoms (which may contain an unsaturated bond or may be branched) and any one of mono-, di-, tri-, tetra-, penta- and hexahydric alcohols having 2 to 12 carbon atoms (which may contain an unsaturated bond or may be branched), fatty acid esters of monoalkyl ethers of alkylene oxide polymers, fatty acid amide having 8 to 22 carbon atoms, and aliphatic amine having 8 to 22 carbon atoms.

Specific examples of the fatty acids include capric acid, caprylic acid, lauric acid, myristic acid, palmitic acid, stearic acid, behenic acid, oleic acid, elaidic acid, linoleic acid, linolenic acid, and isostearic acid. Specific examples of the esters include butyl stearate, octyl stearate, amyl stearate, isooctyl stearate, butyl myristate, octyl myristate, butoxyethyl stearate, butoxydiethyl stearate, 2-ethylhexyl stearate, 2-octyldodecyl palmitate, 2-hexyldodecyl palmitate, isohexadecyl stearate, oleyl oleate, dodecyl stearate, tridecyl stearate, oleyl erucate, neopentyl glycol didecanoate, and ethylene glycol dioleyl. Specific examples of the alcohols include oleyl alcohol, stearyl alcohol, and lauryl alcohol. Alternatively, examples of other additives that can be used include: nonionic surfactants such as alkylene oxide, glycerin, glycidol, and alkylphenol-ethylene oxide adducts; cationic surfactants such as cyclic amine, ester amide, quaternary ammonium salts, hydantoin derivatives, heterocyclic rings, and phosphoniums or sulfoniums; anionic surfactants containing an acidic group such as carboxylic acid, sulfonic acid, phosphoric acid, sulfuric acid ester or phosphoric acid ester groups; and amphoteric surfactants such as amino acids, aminosulfonic acids, sulfuric acid esters or phosphoric acid esters of amino alcohol and alkylbetaine. These surfactants are described in detail in “Surfactant Handbook” (published by Sangyo Tosho Co., Ltd.). These lubricants or anti-static agents are not necessarily 100% pure and may contain impurities such as isomers, unreacted materials, by-products, decomposed products, and oxides, in addition to the main component. The content of such impurities is preferably 30% by mass or less, more preferably 10% by mass or less.

These lubricants or surfactants used in the present embodiment have their respective different physical effects. It is preferred that the type, amount, and proportion (for producing synergistic effects by combined use) of the lubricant should be determined optimally depending on the purpose. Examples of possible effects include, but not limited to: the control of bleeding to the surface by using fatty acids differing in melting point between the non-magnetic layer and the magnetic layer; the control of bleeding to the surface by using esters differing in boiling point, melting point, or polarity; improvement in application stability by adjusting the amount of the surfactant; and improvement in lubrication effects by increasing the amount of the lubricant added to an intermediate layer. In general, the total amount of the lubricant(s) can be in the range of 0.1 to 50% by mass, more preferably 2 to 25% by mass, with respect to the ferromagnetic powders or the non-magnetic powders.

The whole or a portion of the additive used in the present embodiment may be added in any step in the production of an application solution for an undercoat layer, an application solution for a non-magnetic layer, or an application solution for a magnetic layer. For example, the additive may be mixed with the ferromagnetic powders or the non-magnetic powders before a kneading step; the additive may be added during a kneading step using the ferromagnetic powders or the non-magnetic powders, the binder, and the solvent; the additive may be added during a dispersing step; the additive may be added after a dispersing step; or the additive may be added immediately before application. Depending on the purpose, the whole or a portion of the additive may be applied by a simultaneous or successive coating method after the application of the magnetic layer or the non-magnetic layer. Depending on the purpose, the lubricant may be applied onto the surface of the magnetic layer after calender treatment or after slitting treatment. In the present embodiment, organic solvents known in the art can be used. For example, solvents described in Japanese Patent Application Laid-Open No. 6-68453 can be used.

### (Back Coat Layer)

General magnetic recording media (magnetic tapes) for computer data recording are strongly required to have better repetitive running properties than those of video tapes or audio tapes. For maintaining such high running durability, it is preferred that the back coat layer should contain carbon black and inorganic powders.

Examples of the inorganic powders that can be added to the back coat layer include inorganic powders having an average particle size of 80 to 250 nm and Mohs hardness of 5 to 9. For example, α-iron oxide, α-alumina, chromium oxide (Cr₂O₃), and TiO₂ can be used as inorganic powders. Among them, αc-iron oxide and α-alumina are preferably used.

Carbon blacks usually used in magnetic recording media can be used widely as carbon black used in the back coat layer. Examples of the carbon black that can be used can include furnace black for rubber, thermal black for rubber, carbon black for coloring, and acetylene black. Preferably, the carbon black has a particle size of 0.3 μm or smaller, particularly preferably 0.01 to 0.1 μm, for preventing the irregularities of the back coat layer from being reflected in the magnetic layer. It is preferred that the amount of the carbon black used in the back coat layer should be adjusted within the range that provides an optical transmission density of 2.0 or smaller (transmission value measured by TR-927 manufactured by MacBeth).

Two carbon blacks having different average particle sizes are advantageously used for improving running durability. In this case, first carbon black having an average particle size in the range of 0.01 μm to 0.04 μm and second carbon black having an average particle size in the range of 0.05 μm to 0.3 μm are preferably combined. The content of the second carbon black is suitably 0.1 to 10 parts by mass, more preferably 0.3 to 3 parts by mass, with respect to 100 parts by mass in total of the inorganic powders and the first carbon black. Preferably, the amount of the binder used is selected from the range of 40 to 150 parts by mass, more preferably 50 to 120 parts by mass, particularly preferably 60 to 110 parts by mass, with respect to 100 parts by mass in total of the inorganic powders and the carbon blacks. For example, thermoplastic resins, heat-curable resins, reactive resins known in the art can be used as a binder for the back coat layer.

### (Production of Application Solution)

The application solution for an undercoat layer is produced by dissolving the radiation-curable compound and necessary additives in an application solvent.

Processes for producing the application solution for a magnetic layer and the application solution for a non-magnetic layer comprises at least a kneading step, a dispersing step, and a mixing step provided, if necessary, before and after these steps. Each step may have two or more stages. All the raw materials used in the present embodiment (ferromagnetic powders, non-magnetic powders, binder, carbon black, abrasive, anti-static agent, lubricant, solvent, etc.) may be added at the beginning of or during any step. Alternatively, each raw material may be added in divided portions in two or more steps. For example, the binder may be added in divided portions in the kneading step, the dispersing step, and the mixing step for adjusting viscosity after dispersion. To attain the object of the present invention, production techniques known in the art can be used in some steps. A powerful kneading machine such as an open kneader, continuous kneader, pressure kneader, or extruder is preferably used in the kneading step. When a kneader is used, the ferromagnetic powders or the non-magnetic powders can be kneaded in the range of 15 to 500 parts with respect to 100 parts in total of the whole or a portion (preferably 30% by mass or more of the whole binder) of the binder and the ferromagnetic powders. These kneading treatments are described in detail in Japanese Patent Application Laid-Open Nos. 1-106338 and 1-79274. Glass beads can be used for dispersing the application solution for a magnetic layer and the application solution for a non-magnetic layer. Dispersion media having a high specific gravity, for example, zirconia beads, titania beads, or steel beads, are preferably used. It is preferred that the particle size and packing density of these dispersion media should be optimized for use. Dispersing apparatuses known in the art can be used.

### [Method for Producing Magnetic Recording Medium]

In the present embodiment, the magnetic recording medium is produced as follows: an application solution for an undercoat layer containing a radiation-curable compound is applied onto the non-magnetic support and then dried while the radiation-curable compound is cured to thereby form the undercoat layer; an application solution for a non-magnetic layer is then applied onto the undercoat layer and then dried to thereby form the non-magnetic layer; and an application solution for a magnetic layer is then applied onto the non-magnetic layer and then dried to thereby form the magnetic layer. In this procedure, the undercoat layer, the non-magnetic layer, and the magnetic layer are continuously formed in this order onto the non-magnetic support sent from a non-magnetic support master roll to thereby obtain a magnetic recording medium web, which is winded to thereby produce a magnetic recording medium master roll; and the magnetic recording medium web unwound from the magnetic recording medium master roll is cut into tapes to thereby form a magnetic recording medium tape.

The back coat layer may be formed in advance on the back surface of the non-magnetic support. In this case, the non-magnetic support on which the back coat layer has been formed is sent from the non-magnetic support master roll. Alternatively, the undercoat layer, the non-magnetic layer, and the magnetic layer are formed on the non-magnetic support sent alone from the non-magnetic support master roll, and the magnetic recording medium web is winded as the magnetic recording medium master roll. During the procedures from sending to winding, the back coat layer may be applied onto the back surface of the non-magnetic support.

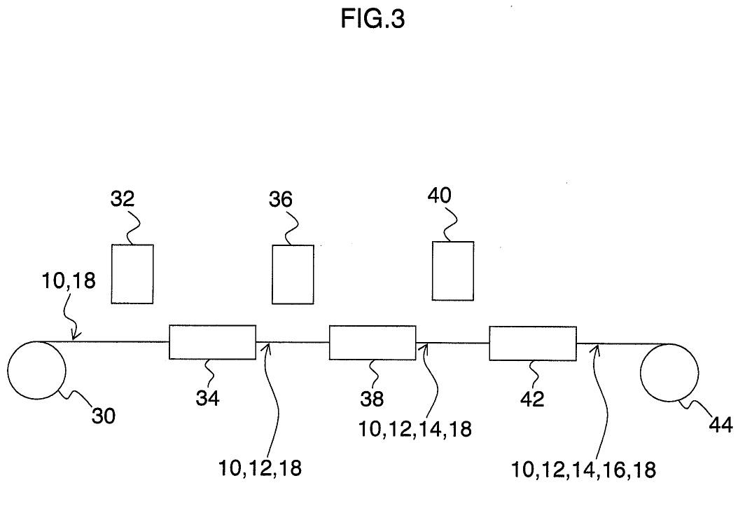

FIG. 3 is a schematic diagram showing one example of a production line of a magnetic recording medium. In the present example, a non-magnetic support 10 having a back surface on which a back coat layer 18 has been formed in advance is winded to form a non-magnetic support master roll 30.

The non-magnetic support 10 on which the back coat layer 18 has been formed is successively sent from the non-magnetic support master roll 30. An application solution for an undercoat layer is applied thereonto by an undercoat layer application portion 32, and the resulting non-magnetic support 10 is sent to an undercoat layer drying/cure portion 34. In the undercoat layer drying/cure portion 34, the application solution for an undercoat layer applied on the non-magnetic support 10 is dried, while a radiation-curable compound contained in the application solution for an undercoat layer is cured by radiation to form an undercoat layer 12 on the surface of the non-magnetic support 10. Next, the non-magnetic support 10 on which the back coat layer 18 and the undercoat layer 12 have been formed is sent to a non-magnetic layer application portion 36. An application solution for a non-magnetic layer is applied onto the undercoat layer 12 by the non-magnetic layer application portion 36, and the resulting non-magnetic support 10 is sent to a non-magnetic layer drying portion 38. In the non-magnetic layer drying portion 38, the application solution for a non-magnetic layer applied on the undercoat layer 12 is dried to form a non-magnetic layer 14 on the surface side of the non-magnetic support 10. Next, the non-magnetic support 10 on which the back coat layer 18, the undercoat layer 12, and the non-magnetic layer 14 have been formed is sent to a magnetic layer application portion 40. An application solution for a magnetic layer is applied onto the non-magnetic layer 14 by the magnetic layer application portion 40, and the resulting non-magnetic support 10 is sent to a magnetic layer drying portion 42. In the magnetic layer drying portion 42, the application solution for a magnetic layer applied on the non-magnetic layer 14 is dried to form a magnetic layer 16 on the surface side of the non-magnetic support 10. The non-magnetic support 10 thus having the back surface on which the back coat layer 18 has been formed and the surface on which the undercoat layer 12, the non-magnetic layer 14, and the magnetic layer 16 have been formed is winded to form a magnetic recording medium master roll 44.

Next, the process for producing the magnetic recording medium will be described in detail.

### (Application Method)

Approaches known in the art such as extrusion coating, roll coating, gravure coating, micro-gravure coating, air knife coating, die coating, curtain coating, dip coating, and wire bar coating methods can be used in the preparation of the undercoat layer, the non-magnetic layer, and the magnetic layer. When the non-magnetic layer and the magnetic layer are applied by a successive multilayer coating method, it is preferred that an extrusion coating method should be used in the preparation of the magnetic layer.

For forming the magnetic layer, it is preferred that a coating method using two slits, a slit for application and a slit for recovery, should be used wherein an application solution is discharged from the slit for application and applied onto a web, and an excess of the application solution is absorbed into the slit for recovery. For the coating method, it is more preferred that pressure conditions for the absorption of an excess of the application solution by the slit for recovery should be optimized to obtain a thinner magnetic layer applied without uneven application.

Specifically, the undercoat layer, the non-magnetic layer, and the magnetic layer are formed on the non-magnetic support that continuously moves. To apply an application solution for a magnetic layer, the non-magnetic layer formed on the non-magnetic support is placed in the proximity of a lip surface at the end of an application head. In this state, the application solution for a magnetic layer sent into the application head is discharged in an amount more excessive than the applied amount required for forming the magnetic layer having the desired film thickness, from the slit for application of the application head onto the non-magnetic layer, while an excess of the application solution for a magnetic layer applied thereon is absorbed from the slit for recovery provided downstream from the slit for application in the moving direction of the non-magnetic support. When a fluid pressure at an absorption port of the slit for recovery is defined as P (MPa), it is preferred that the absorption of the application solution for a magnetic layer by the slit for recovery should be performed to satisfy the following formula (I):

0.05 (MPa)>P≧0 (MPa) (I).

In this coating method, an excess of the application solution for a magnetic layer applied thereon may be absorbed by an absorption pump. In this case, when a pressure on the absorption port side of the absorption pump is defined as PIN (MPa), it is preferred that the absorption of the application solution for a magnetic layer should be performed to satisfy the following formula (II):

PIN≧−0.02 (MPa) (II).

The coating method is described in detail in Japanese Patent Application Laid-Open No. 2003-236452.

In the method for producing the magnetic recording medium of the present embodiment, preferably, the undercoat layer, the non-magnetic layer, and the magnetic layer are continuously formed on the non-magnetic support sent from the non-magnetic support master roll; after the formation of the non-magnetic layer and the magnetic layer, the non-magnetic support is winded to thereby obtain a magnetic recording medium master roll; and a portion of the magnetic recording medium master roll is cut to thereby obtain a magnetic recording medium in a tape form. The production of an inexpensive magnetic recording medium in large amounts is difficult for a method which comprises: sending a non-magnetic support winded in a roll form; forming an undercoat layer and a non-magnetic layer on the non-magnetic support; then temporarily winding the non-magnetic support; sending the non-magnetic support again, and forming a magnetic layer on the non-magnetic support. By contrast, an inexpensive magnetic recording medium can be produced in large amounts by sending a non-magnetic support winded in a roll form, forming an undercoat layer and a non-magnetic layer thereon, and then forming a magnetic layer without winding the non-magnetic support again as described above. It is preferred that during the procedures from the sending to winding of the non-magnetic support, the layer other than the undercoat layer, the non-magnetic layer, and the magnetic layer should also be formed. For example, when a back coat layer is provided, it is preferred that the back coat layer should also be formed during the procedures from the sending to winding of the non-magnetic support.

A non-magnetic support transport speed in the formation of each layer is preferably 100 m/min. or more, more preferably 200 m/min. or more, even more preferably 300 m/min. or more, particularly preferably 400 m/min. or more, for improving productivity. A higher application speed is more advantageous for improving productivity. However, too high an application speed tends to cause application failures (streaking of an application solution, uneven application, etc.) Therefore, the application speed is preferably 700 m/min. or less.

To obtain the desired oriented state of the ferromagnetic powders in the magnetic layer, the application solution for a magnetic layer after the application thereof is usually subjected to orientation treatment in a wet state.

It is preferred that ferromagnetic metal powders should be oriented in the longitudinal direction using a cobalt magnet and solenoid. Hexagonal ferrite powders generally tend to take three-dimensional random orientation of in-plane and in the perpendicular directions and however, can be allowed to take in-plane two-dimensional random orientation. Alternatively, perpendicular orientation can be formed by methods known in the art such as magnets with different polarities facing each other to thereby impart isotropic magnetic characteristics in the circumferential direction to the magnetic layer. Particularly, perpendicular orientation is preferable for high-density recording.

The application solution for forming each layer can be dried, for example, by blowing hot air on the application solution applied. Preferably, the temperature of the drying air should be set to 60° C. or higher. The quantity of the drying air may be selected according to the amount of the application solution applied and the temperature of the drying air. The application solution for a magnetic layer after the application thereof can be subjected to moderate preliminary drying and then introduced into a magnet zone for orientation treatment.

After the thus-performed application and drying of the application solution for forming each layer, the magnetic recording medium is usually subjected to calender treatment. A heat-resistant plastic roll or metal roll such as epoxy, polyimide, polyamide, or polyimideamide can be used as a roll for calender treatment. The temperature of the calender treatment is preferably 50° C. or higher, more preferably 90° C. or higher. A linear pressure in the calender treatment is preferably 200 kg/cm (196 kN/m) or more, more preferably 300 kg/cm (294 kN/m) or more.

### EXAMPLES

Hereinafter, specific Examples and Comparative Examples according to the present invention will be described. However, the present invention is not intended to be limited to these Examples. In Examples below, the term “part” represents “part by weight”.

### (Non-Magnetic Support A)

A non-magnetic support A was prepared as follows: a commercially available polyethylene 2,6-naphthalate film (Q24SC, manufactured by Teijin Ltd.) having a single-layer structure was used and made into a film thickness of 5.0 μm.

A center line average surface roughness (Ra) was measured on the side where a magnetic layer was applied. As a result, it was 8.5 nm.

The center line average surface roughness (Ra) was calculated from the surface mean of the square in image analysis software by measuring a 265×350 μm region using a versatile three-dimensional surface structure analyzer NewView 5022 manufactured by Zygo Corporation. The measurement was performed in an atmosphere of 23° C. and 50% RT.

### (Non-Magnetic Support B)

A non-magnetic support B was prepared as follows: a resin component which contained 0.30% by mass of silica fine particles in a spherical form having an average particle size of 0.1 μm and a particle size distribution value of 1.6 and 0.02% by mass of silicone fine particles in a spherical form having an average particle size of 0.5 μm and a particle size distribution value of 1.2 and had a 50/50 ratio by mass of polyethylene-2,6-naphthalate (PEN) having a mass-average molecular weight of 30000 to PEN having a mass-average molecular weight of 45000, was dried at 180° C. for 5 hours, then supplied to a hopper of an extruder, and molten at 300° C. in the extruder. The molten mixture was extruded through a T-shaped extrusion die and rapidly cooled for solidification on a casting drum surface-finished at 0.3 S and kept at a surface temperature of 60° C. to prepare an unstretched film.

The unstretched film thus obtained was preheated at 120° C. and further heated between low-speed and high-speed rolls with an infrared heater at a surface temperature of 830° C. from 14 mm above to stretch the film by 5.4 times. This film was rapidly cooled and subsequently supplied to a stenter to stretch the film by 4.8 times in the transverse direction at 125° C. The obtained film was successively fixed by heat at 225° C. for 3 seconds to prepare a single-layer non-magnetic support B having a film thickness of 5.0 μm.

The average particle size of the inactive fine particles was determined by converting measurement values of approximately 100 particles obtained based on electron micrography into an equivalent sphere and calculating a particle size (D50) that shows 50% with respect to the whole volume. The particle size distribution value was determined by measuring an integrated volume of the particles from the largest particles and using a ratio (D25/D75) of a particle size (D25) that shows 25% with respect to the whole volume to a particle size (D75) that shows 75% with respect thereto.

A center line average surface roughness (Ra) on the side where a magnetic layer was applied was measured in the same way as in the non-magnetic support A. As a result, it was 8.4 nm.

### (Non-Magnetic Support C)

A non-magnetic support C was prepared as follows: a single-layer non-magnetic support C having a film thickness of 5.0 μm was prepared in the same way as in the non-magnetic support B except that a resin component was used which contained 0.10% by mass of silica fine particles in a spherical form having an average particle size of 0.1 μm and a particle size distribution value of 1.4 and 0.15% by mass of silica fine particles in a spherical form having an average particle size of 0.3 μm and a particle size distribution value of 1.3 and had a 50/50 ratio by mass of polyethylene-2,6-naphthalate (PEN) having a mass-average molecular weight of 30000 to PEN having a mass-average molecular weight of 45000.

A center line average surface roughness (Ra) on the side where a magnetic layer was applied was measured in the same way as in the non-magnetic support A. As a result, it was 12.9 nm.

### (Non-Magnetic Support D)

A non-magnetic support D was prepared as follows: a single-layer non-magnetic support D having a film thickness of 5.0 μm was prepared in the same way as in the non-magnetic support B except that a resin component was used which contained 0.10% by mass of alumina fine particles having an average particle size of 0.12 μm and a particle size distribution value of 1.8 and 0.15% by mass of silica fine particles in a spherical form having an average particle size of 0.3 μm and a particle size distribution value of 1.2 and had a 50/50 ratio by mass of polyethylene-2,6-naphthalate (PEN) having a mass-average molecular weight of 30000 to PEN having a mass-average molecular weight of 45000.

A center line average surface roughness (Ra) on the side where a magnetic layer was applied was measured in the same way as in the non-magnetic support A. As a result, it was 13.1 nm.

### (Non-Magnetic Support E)

A non-magnetic support E was prepared as follows: a single-layer non-magnetic support E having a film thickness of 5.0 μm was prepared in the same way as in the non-magnetic support B except that a resin component was used which contained 0.10% by mass of silica fine particles in a spherical form having an average particle size of 0.1 μm and a particle size distribution value of 1.4 and 0.12% by mass of silica fine particles in a spherical form having an average particle size of 0.3 μm and a particle size distribution value of 1.7 and had a 50/50 ratio by mass of polyethylene-2,6-naphthalate (PEN) having a mass-average molecular weight of 30000 to PEN having a mass-average molecular weight of 45000.

A center line average surface roughness (Ra) on the side where a magnetic layer was applied was measured in the same way as in the non-magnetic support A. As a result, it was 15.3 nm.

### (Non-Magnetic Support F)

A non-magnetic support F was prepared as follows: a commercially available polyethylene 2,6-naphthalate film (Q34SD, manufactured by Teijin Ltd.) having a double-layer structure was used and made into a film thickness of 5.0 μm.

A center line average surface roughness (Ra) on the smooth surface side where a magnetic layer was applied was measured in the same way as in the non-magnetic support A. As a result, it was 3.4 nm

### (Non-Magnetic Support G)

A non-magnetic support G was prepared as follows: a resin component A which contained 0.10% by mass of silica fine particles in a spherical form having an average particle size of 0.1 μm and a particle size distribution value of 1.4 and had a 50/50 ratio by mass of polyethylene-2,6-naphthalate (PEN) having a mass-average molecular weight of 30000 to PEN having a mass-average molecular weight of 45000, and a resin component B which contained 0.10% by mass of silica fine particles in a spherical form having an average particle size of 0.1 μm and a particle size distribution value of 1.4 and 0.15% by mass of silica fine particles in a spherical form having an average particle size of 0.3 μm and a particle size distribution value of 1.3 and had a 50/50 ratio by mass of PEN having a mass-average molecular weight of 30000 to PEN having a mass-average molecular weight of 45000, were separately dried at 180° C. for 5 hours, then supplied to a hopper of an extruder, and molten at 300° C. in the extruder. The molten mixtures were layered such that the resin components A and B were positioned on a surface A (on the surface side) and a surface B (on the back surface side), respectively. In this layered state, the resulting product was extruded through a T-shaped extrusion die onto a casting drum surface-finished at 0.3 S and kept at a surface temperature of 60° C., and rapidly cooled for solidification to prepare a layered unstretched film.

The unstretched film thus obtained was preheated at 120° C. and further heated between low-speed and high-speed rolls with an infrared heater at a surface temperature of 830° C. from 14 mm above to stretch the film by 5.4 times. This film was rapidly cooled and subsequently supplied to a stenter to stretch the film by 4.8 times in the transverse direction at 125° C. The obtained film was successively fixed by heat at 225° C. for 3 seconds to prepare a double-layer non-magnetic support F having a film thickness of 5.0 μm. The film thicknesses of the PEN layers forming the surfaces A and B were adjusted to 1.7 μm and 3.3 μm, respectively.

A center line average surface roughness (Ra) on the surface A side where a magnetic layer was applied was measured in the same way as in the non-magnetic support A. As a result, it was 3.7 nm.

### (Preparation of Application Solution a for Undercoat Layer)

To 20 parts of a commercially available urethane acrylate monomer (EBECRYL 4858, manufactured by Daicel Cytec Co., Ltd.), 64 parts of methyl ethyl ketone and 16 parts of cyclohexanone were added, and this mixture was stirred. This stirred product was filtered through a filter having an average pore size of 0.04 μm to prepare an application solution a for an undercoat layer.

### (Preparation of Application Solution b for Undercoat Layer)

To 10 parts of a commercially available urethane acrylate monomer (EBECRYL 4858, manufactured by Daicel Cytec Co., Ltd.) and 10 parts of tricyclodecanedimethanol diacrylate, 64 parts of methyl ethyl ketone and 16 parts of cyclohexanone were added, and this mixture was stirred. This stirred product was filtered through a filter having an average pore size of 0.04 μm to prepare an application solution b for an undercoat layer.

### (Preparation of Application Solution c for Undercoat Layer)

To 12 parts of a commercially available urethane acrylate monomer (EBECRYL 4858, manufactured by Daicel Cytec Co., Ltd.) and 8 parts of dipentaerythritol hexaacrylate, 64 parts of methyl ethyl ketone and 16 parts of cyclohexanone were added, and this mixture was stirred. This stirred product was filtered through a filter having an average pore size of 0.04 μm to prepare an application solution c for an undercoat layer.

### (Preparation of Application Solution A for Magnetic Layer)

Ferromagnetic metal particles, a phosphoric acid-based dispersing agent, 6 parts of a polyurethane-based resin PU1 (mass-average molecular weight (Mw): 170,000), 6 parts of a polyurethane-based resin PU2 (mass-average molecular weight (Mw): 80,000) similar in molecular structure to the polyurethane-based resin PU1, 9 parts of a polyvinyl chloride-based resin (MR110, manufactured by Zeon Corp.), methyl ethyl ketone, and cyclohexanone shown below were used and kneaded and dispersed with an open kneader known in the art. To the prepared kneaded product, α-alumina and carbon black shown below were added, and this mixture was subjected to dispersion treatment with a DYNO-mill (zirconia beads of 0.5 mm in diameter) known in the art to prepare a dispersion solution of the ferromagnetic metal particles.

| | | |
|---|---|---|
| Ferromagnetic metal particles (needle-like) | 100 | parts |
| Composition: Fe/Co = 100/25 | | |
| Coercive force Hc: 215 kA/m (2700 Oe) | | |
| Specific surface area (BET method): 70 m²/g | | |
| Surface treatment agent: Al₂O₃, SiO₂, and Y₂O₃ | | |
| Average longer axis diameter: 45 nm | | |
| Average acicular ratio: 4 | | |
| Saturation magnetization σs: 110 A · m²/kg (110 emu/g) | | |
| Phosphoric acid-based dispersing agent | 5 | parts |
| Polyurethane-based resin PU1 (mass-average molecular | 6 | parts |
| weight (Mw): 170,000) | | |
| (Polar group-SO₃Na content: 70 eq./ton) | | |
| Polyurethane-based resin PU2 (mass-average molecular | 6 | parts |
| weight (Mw): 80,000) | | |
| (Polar group-SO₃Na content: 70 eq./ton) | | |
| Polyvinyl chloride-based resin (MR110, manufactured | 9 | parts |
| by Zeon Corp.) | | |
| α-alumina (Mohs hardness: 9, average particle | 3 | parts |
| size: 0.1 μm) | | |
| Carbon black (average particle size: 0.08 μm) | 0.3 | parts |
| Methyl ethyl ketone | 150 | parts |
| Cyclohexanone | 150 | parts |

To the prepared dispersion solution, polyisocyanate, butyl stearate, stearic acid, methyl ethyl ketone, and cyclohexanone shown below were added, and this mixture was stirred. The stirred product was subjected to dispersion treatment with an ultrasonic dispersing machine known in the art. This stirred product was then filtered through a filter having an average pore size of 1.0 μm to prepare an application solution for a magnetic layer. The solid content of the application solution for a magnetic layer was set to 17.0% by mass.

| | | |
|---|---|---|
| Polyisocyanate (Coronate L, manufactured by | 4 | parts |
| Nippon Polyurethane Industry Co., Ltd.) | | |
| Butyl stearate | 1.5 | parts |
| Stearic acid | 0.5 | parts |
| Methyl ethyl ketone | 252 | parts |
| Cyclohexanone | 118 | parts |

(Preparation of application solution B for magnetic layer)

An application solution B for a magnetic layer was prepared in totally the same way as in the application solution A for a magnetic layer except that the polyurethane resin PU1 was changed to a polyurethane resin PU2.

### (Preparation of Application Solution C for Magnetic Layer)

An application solution C for a magnetic layer was prepared in totally the same way as in the application solution A for a magnetic layer except that 3 parts of the α-alumina (average particle size: 0.1 μm) was changed to 10 parts of α-alumina (average particle size: 0.20 μm).

### (Preparation of Application Solution for Non-Magnetic Layer)

Non-magnetic metal particles, carbon black, a phosphoric acid-based dispersing agent, a polyvinyl chloride-based resin, a polyurethane-based resin, methyl ethyl ketone, and cyclohexanone shown below were used and kneaded and dispersed with an open kneader known in the art.

The prepared kneaded product was subjected to dispersion treatment with a DYNO-mill (zirconia beads of 0.5 mm in diameter) known in the art to prepare a dispersion solution of the non-magnetic particles.

| | | |
|---|---|---|
| Non-magnetic particles αFe₂O3 (needle-like) | 80 | parts |
| Specific surface area (BET method): 52 m²/g | | |
| Surface treatment agent: Al₂O₃ and SiO₂ | | |
| Average longer axis diameter: 100 nm | | |
| pH: 9.0 | | |
| Tap density: 0.8 g/cc | | |
| DBP oil absorption: 27 to 38 g/100 g | | |
| Carbon black | 20 | parts |
| Average primary particle diameter: 0.016 μm | | |
| DBP oil absorption: 120 mL/100 g | | |
| pH: 8.0 | | |
| Specific surface area (BET method): 250 m²/g | | |
| Volatile portions: 1.5% | | |
| Phosphoric acid-based dispersing agent | 3 | parts |
| Polyvinyl chloride-based resin (MR110, manufactured by | 12 | parts |
| Zeon Corp.) | | |
| Polyurethane-based resin | 7.5 | parts |
| (branched side chain-containing polyester | | |
| polyol/diphenylmethane diisocyanate-based, | | |
| polar group-SO₃Na group content: 70 eq./ton) | | |
| Methyl ethyl ketone | 150 | parts |
| Cyclohexanone | 150 | parts |

To the prepared dispersion solution, polyisocyanate, butyl stearate, stearic acid, methyl ethyl ketone, and cyclohexanone shown below were added, and this mixture was stirred. The stirred product was subjected to dispersion treatment with an ultrasonic dispersing machine known in the art. This stirred product was then filtered through a filter having an average pore size of 1.0 μm to prepare an application solution for a non-magnetic layer.

| | | |
|---|---|---|
| Polyisocyanate (Coronate L, manufactured by | 5 | parts |
| Nippon Polyurethane Industry Co., Ltd.) | | |
| Butyl stearate | 1.5 | parts |
| Stearic acid | 1 | part |
| Methyl ethyl ketone | 5 | parts |
| Cyclohexanone | 75 | parts |

(Preparation of application solution for back coat layer)

Raw materials and solvents shown below were subjected to kneading treatment by an approach known in the art and then subjected to dispersion treatment with a DYNO-mill (zirconia beads of 0.5 mm in diameter) known in the art.

| | | |
|---|---|---|
| Carbon black A (average particle size: 0.04 μm) | 100 | parts |
| Carbon black B (average particle size: 0.1 μm) | 4 | parts |
| Non-magnetic particles αFe₂O₃ | 10 | parts |
| (average particle size: 0.11 μm, Mohs hardness: 5, pH: 9.0) | | |
| α-alumina (average particle size: 0.2 μm) | 1 | part |
| Nitrocellulose (Cellnova BTH1/2, manufactured | 35 | parts |
| by Asahi Kasei Corp.) | | |
| Polyurethane-based resin | 70 | parts |
| Copper phthalocyanine-based dispersing agent | 5 | parts |
| Copper oleate | 5 | parts |
| Precipitated barium sulfate | 5 | parts |
| Methyl ethyl ketone | 700 | parts |
| Toluene | 700 | parts |

To the prepared dispersion solution, raw materials shown below were added, and this mixture was stirred. This stirred product was filtered through a filter having an average pore size of 1.0 μm to prepare an application solution for a back coat layer.

| | |
|---|---|
| Polyester-based resin (Vylon 300, manufactured by | 5 parts |
| TOYOBO Co., Ltd.) | |
| Polyisocyanate(Coronate L, manufactured by Nippon | 15 parts |
| Polyurethane Industry Co., Ltd.) | |

(Magnetic recording medium preparation-1

### (EXAMPLE 1-1)

The application solution a for an undercoat layer was applied onto the non-magnetic support A by an approach known in the art and dried. While excessive oxygen was substituted by nitrogen (nitrogen purge), the radiation-curable compound was cured by electron beam irradiation at a dose of 5 Mrad in an atmosphere with an oxygen concentration lower than 50 ppm to prepare an undercoat layer having a film thickness of 0.4 μm.

Onto the prepared undercoat layer, the application solution for a non-magnetic layer thus prepared was applied at a film thickness (after drying) of 0.6 μm by an approach known in the art and dried to prepare a non-magnetic layer.

Onto the prepared non-magnetic layer, the application solution for a magnetic layer thus prepared was applied at a film thickness (after drying) of 0.06 μm by an approach described in Japanese Patent Application Laid-Open No. 2003-236452.

After the application of the application solution A for a magnetic layer (after 0.7 seconds thereof), the application solution for a magnetic layer was subjected to orientation treatment in a wet state with a cobalt magnet having magnetic force of 0.5 T (5000 G) and solenoid having magnetic force of 0.4 T (4000 G) and then dried to prepare a magnetic layer.

On the side of the non-magnetic support A opposite to the magnetic layer (on the back surface side thereof), the application solution for a back coat layer thus prepared was applied at a thickness (after drying) of 0.5 μm by an approach known in the art and dried to prepare a back coat layer.

During procedures from the sending to winding of the non-magnetic support A, four layers, that is, the undercoat layer, the non-magnetic layer, the magnetic layer, and the back coat layer, were applied in this order. Moreover, a non-magnetic support transport speed was set to 350 m/min.

Then, the non-magnetic support on which the undercoat layer, the non-magnetic layer, the magnetic layer, and the back coat layer have been formed was subjected to surface smoothing treatment at a speed of 150 m/min. using a 7-stage calender treatment machine (linear pressure: 300 kg/cm) equipped with a metal roll (temperature: 100° C.). The thus-surface-smoothed magnetic recording medium was subsequently subjected to heat treatment at 70° C. for 40 hours and then slit into a ½ inch width to prepare a magnetic recording medium in a tape form.

### Example 1-2

A magnetic recording medium in a tape form was prepared in totally the same way as in Example 1-1 except that the non-magnetic support B was used.

### Example 1-3

A magnetic recording medium in a tape form was prepared in totally the same way as in Example 1-1 except that the non-magnetic support C was used.

### Example 1-4

A magnetic recording medium in a tape form was prepared in totally the same way as in Example 1-1 except that the non-magnetic support D was used.

### Example 1-5

A magnetic recording medium in a tape form was prepared in totally the same way as in Example 1-1 except that the non-magnetic support E was used.

### Comparative Example 1-A

A magnetic recording medium in a tape form was prepared in totally the same way as in Example 1-1 except that the non-magnetic support F was used.

### Comparative Example 1-B

A magnetic recording medium in a tape form was prepared in totally the same way as in Example 1-1 except that the non-magnetic support G was used.

### Example 1-6

The application solution b for an undercoat layer was applied onto the non-magnetic support A by an approach known in the art and dried. While excessive oxygen was substituted by nitrogen (nitrogen purge), the radiation-curable compound was cured by electron beam irradiation at a dose of 5 Mrad in an atmosphere with an oxygen concentration lower than 50 ppm to prepare an undercoat layer having a film thickness of 0.3 μm.

Onto the prepared undercoat layer, the application solution for a non-magnetic layer thus prepared was applied at a film thickness (after drying) of 0.7 μm by an approach known in the art and dried to prepare a non-magnetic layer.

The other procedures were performed in totally the same way as in Example 1-1 to prepare a magnetic recording medium in a tape form.

### Example 1-7

A magnetic recording medium in a tape form was prepared in totally the same way as in Example 1-6 except that the non-magnetic support B was used.

### Example 1-8

A magnetic recording medium in a tape form was prepared in totally the same way as in Example 1-6 except that the non-magnetic support C was used.

### Example 1-9

A magnetic recording medium in a tape form was prepared in totally the same way as in Example 1-6 except that the non-magnetic support D was used.

### Example 1-10

A magnetic recording medium in a tape form was prepared in totally the same way as in Example 1-6 except that the non-magnetic support E was used.

### Comparative Example 1-C

A magnetic recording medium in a tape form was prepared in totally the same way as in Example 1-6 except that the non-magnetic support F was used.

### Comparative Example 1-D

A magnetic recording medium in a tape form was prepared in totally the same way as in Example 1-6 except that the non-magnetic support G was used.

### Example 1-11

The application solution a for an undercoat layer was applied onto the non-magnetic support C by an approach known in the art and dried. While excessive oxygen was substituted by nitrogen (nitrogen purge), the radiation-curable compound was cured by electron beam irradiation at a dose of 5 Mrad in an atmosphere with an oxygen concentration lower than 50 ppm to prepare an undercoat layer having a film thickness of 0.2 μm.

Onto the prepared undercoat layer, the application solution for a non-magnetic layer thus prepared was applied at a film thickness (after drying) of 0.8 μm by an approach known in the art and dried to prepare a non-magnetic layer.

The other procedures were performed in totally the same way as in Example 1-1 to prepare a magnetic recording medium in a tape form.

### Example 1-12

The application solution a for an undercoat layer was applied onto the non-magnetic support C by an approach known in the art and dried. While excessive oxygen was substituted by nitrogen (nitrogen purge), the radiation-curable compound was cured by electron beam irradiation at a dose of 5 Mrad in an atmosphere with an oxygen concentration lower than 50 ppm to prepare an undercoat layer having a film thickness of 0.5 μm.

Onto the prepared undercoat layer, the application solution for a non-magnetic layer thus prepared was applied at a film thickness (after drying) of 0.5 μm by an approach known in the art and dried to prepare a non-magnetic layer.

The other procedures were performed in totally the same way as in Example 1-1 to prepare a magnetic recording medium in a tape form.

### Example 1-13

The application solution a for an undercoat layer was applied onto the non-magnetic support C by an approach known in the art and dried. While excessive oxygen was substituted by nitrogen (nitrogen purge), the radiation-curable compound was cured by electron beam irradiation at a does of 5 Mrad in an atmosphere with an oxygen concentration of 200 ppm to prepare an undercoat layer having a film thickness of 0.3 μm.

Onto the prepared undercoat layer, the application solution for a non-magnetic layer thus prepared was applied at a film thickness (after drying) of 0.7 μm by an approach known in the art and dried to prepare a non-magnetic layer.

The other procedures were performed in totally the same way as in Example 1-1 to prepare a magnetic recording medium in a tape form.

### Example 1-14

A magnetic recording medium in a tape form was prepared in totally the same way as in Example 1-13 except that the oxygen concentration in the atmosphere during the cure treatment of the radiation-curable compound was set to 500 ppm.

### Example 1-15

A magnetic recording medium in a tape form was prepared in totally the same way as in Example 1-13 except that the oxygen concentration in the atmosphere during the cure treatment of the radiation-curable compound was set to 1000 ppm.

### Example 1-16

A magnetic recording medium in a tape form was prepared in totally the same way as in Example 1-3 except that the film thickness of the back coat layer was set to 1.2 μm.

### Example 1-17

A magnetic recording medium in a tape form was prepared in totally the same way as in Example 1-11 except that the application solution c for an undercoat layer was used.

### Example 1-18

A magnetic recording medium in a tape form was prepared in totally the same way as in Example 1-3 except that the application solution A for a magnetic layer was changed to the application solution B for a magnetic layer.

### Example 1-19

A magnetic recording medium in a tape form was prepared in totally the same way as in Example 1-3 except that the application solution A for a magnetic layer was changed to the application solution C for a magnetic layer.

### Comparative Example 1-E

A magnetic recording medium in a tape form was prepared in totally the same way as in Comparative-Example 1-A except that the non-magnetic support F was used and no undercoat layer was applied.

### (Evaluation of Magnetic Recording Medium)

The magnetic recording media prepared in Examples 1-1 to 1-19 and Comparative Examples 1-A to 1-E were evaluated for items below.

### (1) Evaluation on Cupping in Magnetic Recording Medium

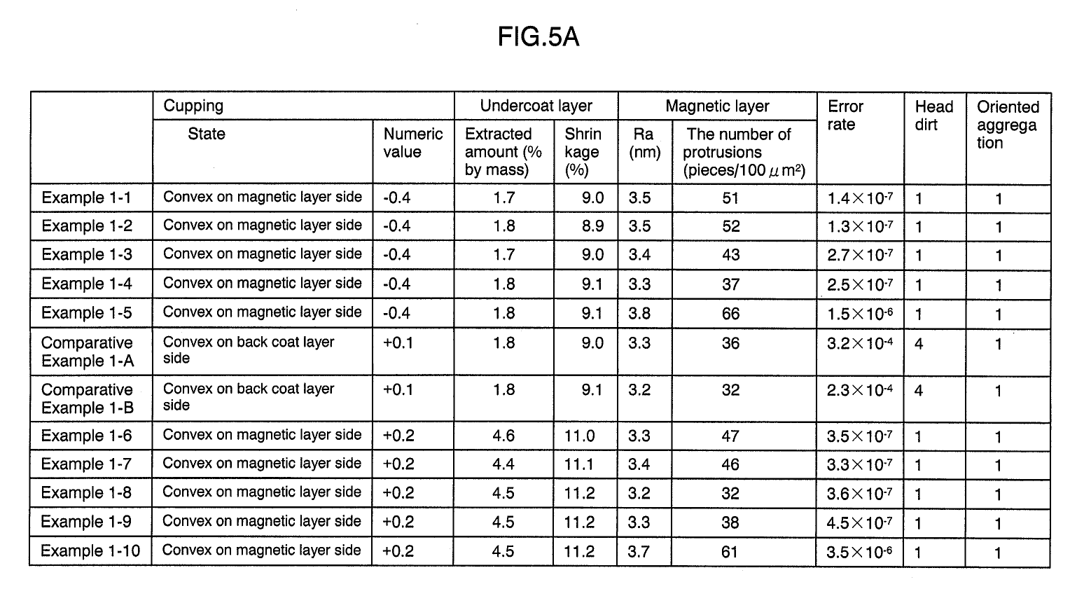

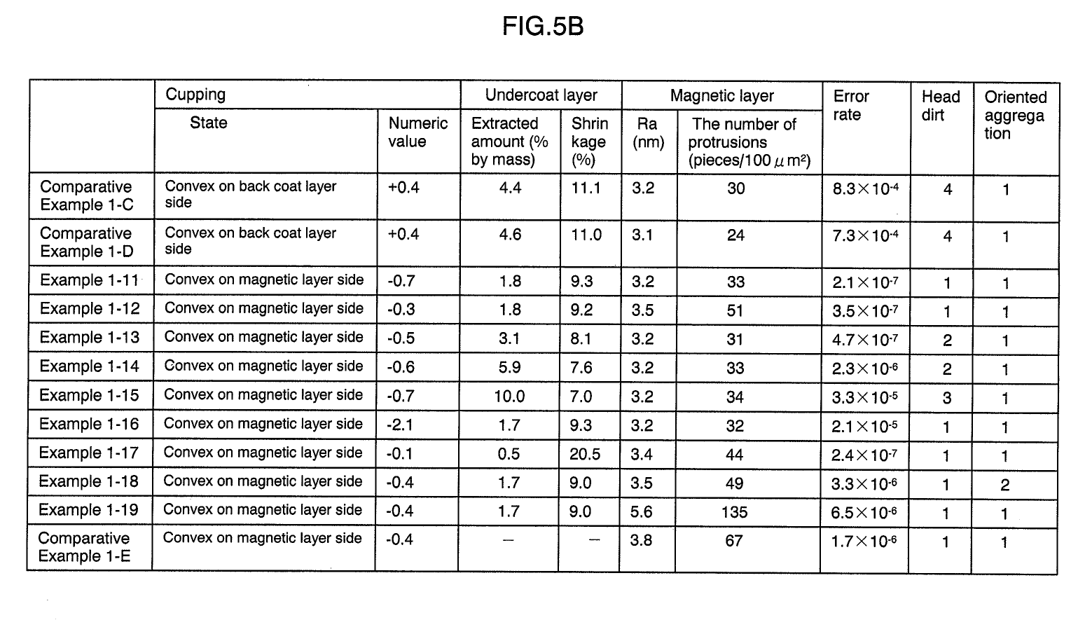

The ½ inch-wide magnetic recording medium in a tape form was evaluated for the state and numeric value of cupping using a measuring microscope (MM-60/L3T, manufactured by Nikon Corp.) (see the items of “Cupping” in Table 2 of FIGS. 5A and 5B). The evaluation method was performed as described above.

### (2) Evaluation on Extraction Rate of Extraction Component in Undercoat Layer

The undercoat layer prepared by applying the application solution onto the non-magnetic support and curing the radiation-curable compound was immersed for 2 hours in the application solvent used in the application of the non-magnetic layer. Components of the undercoat layer extracted into the application solvent were collected. The extraction was performed at an application solvent temperature set to 40° C.

The amount of the components extracted was calculated using liquid chromatography (LC-2010C, manufactured by Shimadzu Corp.). The proportion ((B/A)×100) of a mass B of the components extracted from the undercoat layer used to a mass A of the undercoat layer was calculated (see the item “Extracted amount (% by mass)” of “Undercoat layer” in Table 2 of FIGS. 5A and 5B).

### (3) Evaluation on Volume Shrinkage of Undercoat Layer

The undercoat layer prepared by applying the application solution onto the non-magnetic support and curing the radiation-curable compound was stripped off, and a density A of the undercoat layer after cure was measured. Furthermore, a density B of the undercoat layer before the cure of the radiation-curable compound was measured. A dry densitometer (AccuPyc 1330, manufactured by Shimadzu Corp.) was used in the density evaluation. The volume shrinkage of the undercoat layer was calculated from the calculation formula: (1-B/A)×100 (see the item “Shrinkage (%) of “Undercoat layer” in Table 2 of FIGS. 5A and 5B).

### (4) Evaluation on Surface Roughness of Magnetic Layer

The prepared magnetic recording medium was evaluated using an atomic force microscope (AFM) (Nanoscope 3, manufactured by Digital Instruments, Inc.) for a center line average surface roughness (Ra) on the surface (100 μm²) of the magnetic layer and the number of fine protrusions having a height of 10 to 20 nm on the surface thereof (see the items of “Magnetic layer” in Table 2 of FIGS. 5A and 5B). An SiN probe in a quadrangular pyramid shape having a sharpness of 70° was used. In the magnetic recording medium of the present embodiment, the magnetic layer forms the outermost layer on the surface side of the magnetic recording medium. Therefore, the surface states of the magnetic layer, such as the center line average surface roughness (Ra) or the number of protrusions, can be regarded as the surface states of the magnetic recording medium.

### (5) Evaluation on Error Rate

In the prepared magnetic recording medium, signals with a linear recording density of 144 kbpi were recorded using an LTO-Genl drive in an 8-10 conversion PRI equalization manner. Then, the recorded signals were read out using an LTO-Genl (manufactured by IBM) drive to measure an error rate (see the item “Error rate” in Table 2 of FIGS. 5A and SB). A lower value of the error rate means the occurrence of fewer errors.

### (6) Evaluation on Magnetic Head Dirt

The prepared magnetic recording medium was subjected to regeneration and rewinding operations repeated 100 times in an atmosphere of 23° C. and 50% RH using an MR head-mounted drive known in the art. After the running of the magnetic recording medium, the degree of dirt attached to the magnetic head was observed with a microscope and evaluated on a scale of 1 to 4 below (see the item “Head dirt” in Table 2 of FIGS. 5A and 5B). Less dirt attached to the magnetic head is more preferable.
1: dirt is hardly present
2: trace amount of dirt is present
3: dirt is slightly present
4: large amount of dirt is present
   (7) Evaluation on Aggregated State of Ferromagnetic Metal Particles attributed to Magnetic Field Orientation

The surface of the magnetic layer in the magnetic recording medium was observed with a scanning electron microscope (SEM, magnification: 10000 times) to determine whether the aggregation of the ferromagnetic metal particles (oriented aggregation) was present in the direction of application of the magnetic recording medium. The degree of oriented aggregation was evaluated on a scale of 1 to 3.
1: no oriented aggregation is present
2: oriented aggregation is slightly present
3: significant oriented aggregation is present throughout surface

### (Evaluation Results)

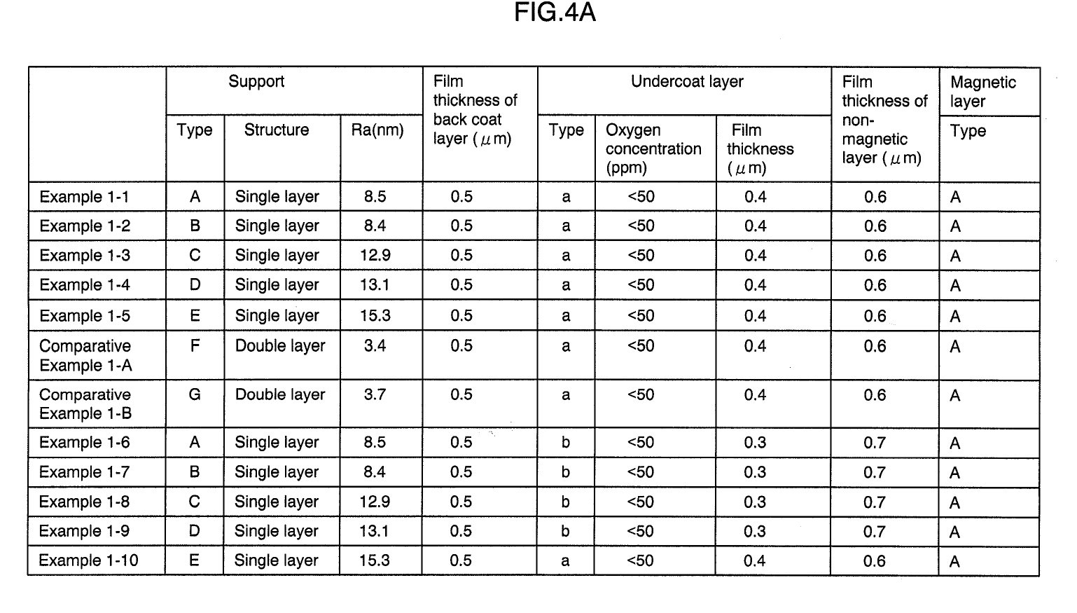

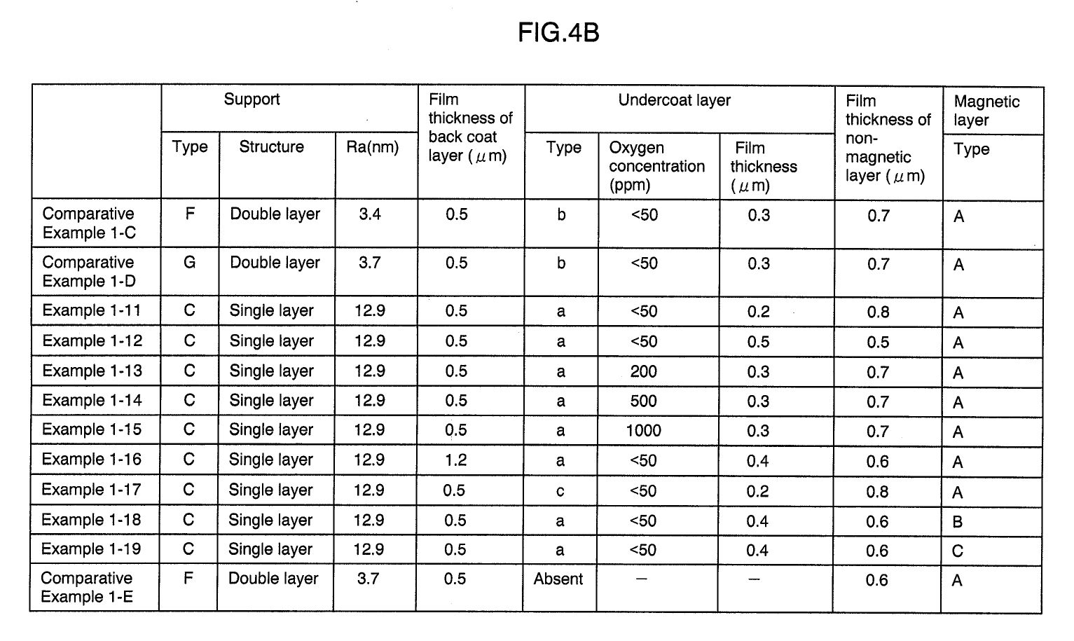

The evaluation test results of each sample are shown in FIGS. 4A and 4B (Table 1), and FIGS. 5A and 5B (Table 2). In Table 1 of FIGS. 4A and 4B, the symbols “A” to “G” in the columns of the item “Type” of “Support” represent the non-magnetic supports A to G, respectively. The symbols “a” to “c” in the columns of the item “Type” of “Undercoat layer” represent the application solutions a to c for an undercoat layer, respectively. The columns of “Oxygen concentration (ppm)” represent an oxygen concentration in the atmosphere during the radiation exposure of the radiation-curable compound. The symbol “<50” in the columns of “Oxygen concentration (ppm)” means that the radiation-curable compound was exposed to radiation in an atmosphere with an oxygen concentration less than 50 ppm. The symbols “A” to “C” in the columns of the item “Type” of “Magnetic layer” represent the application solutions A to C for a magnetic layer, respectively. In Table 2 of FIGS. 5A and 5B, the term “convex on magnetic layer side” in the columns of the item “State” of “Cupping” means that cupping is formed such that the magnetic recording medium protrudes on the surface side where the magnetic layer is placed. The term “convex on back coat layer side” means that cupping is formed such that the magnetic recording medium protrudes on the back surface side where the back coat layer is placed.

As can be seen from the results of Table 2, the amount of cupping was minus in the magnetic recording media (Examples 1-1 to 1-19) in which the undercoat layer containing a radiation-curable compound was applied on the single-layer non-magnetic support. By contrast, the amount of cupping was plus in the magnetic recording media (Comparative Examples 1-A to 1-D) in which the undercoat layer containing a radiation-curable compound was applied on the double-layer non-magnetic support. These results demonstrates that in the preparation of a magnetic recording medium having an undercoat layer containing a radiation-curable compound, the use of a single-layer non-magnetic support easily produces a magnetic recording medium having an amount of cupping that exhibits a minus value. Moreover, it was also demonstrated that a smaller error rate is obtained in the magnetic recording media (Examples 1-1 to 1-19) according to the present invention in which the amount of cupping is minus (cupping is convex on the side having the magnetic layer), than in the magnetic recording media (Comparative Examples 1-A to 1-D) in which the amount of cupping is plus (cupping is concave on the side having the magnetic layer). The high error rate in Comparative Examples 1-A to 1-D may be because: when the amount of cupping was plus, the tape edge was easily rubbed by contact with the magnetic head, and trashes generated from the rubbing made the magnetic head dirty; and a space loss was easily caused due to poor contact between the magnetic head and the magnetic recording medium. On the other hand, an error rate was slightly larger in Example 1-16 in which the amount of cupping was lower than -2.0 mm, than in Examples 1-1 to 1-15. This may be because the contact between the magnetic head and the magnetic recording medium was slightly deteriorated. The amount of cupping is preferably 0 mm or less and larger than −2.1 mm, more preferably 0 mm to -2.0 mm.

In the comparison of Example 1-3 with Examples 1-13 to 1-15, a lower error rate was obtained in a smaller extraction rate of the components extracted from the undercoat layer. A smaller extraction rate of the extracted components tended to result in less dirt of the magnetic head. As a result of analysis of components in the dirt of the magnetic head, it was demonstrated that components similar to the extracted components are detected. From these results, it is preferred that the radiation-curable compound should be cured such that an extraction rate of the components extracted from the undercoat layer is low.

In Example 1-17, a magnetic recording medium in which the amount of cupping is minus can be prepared even with the undercoat layer having a shrinkage of 20.5%.

The preparation of the magnetic recording media of Examples 1-1 to 1-17 according to the present invention caused no oriented aggregation in the magnetic layer, which deteriorates electromagnetic conversion characteristics. On the other hand, in Example 1-18, oriented aggregation in the magnetic layer was slightly observed. In Example 1-18, an error rate was higher than in Example 1-3. This may be because the oriented aggregation slightly deteriorated the error rate. These results in Examples 1-1 to 1-17 suggest that oriented aggregation which deteriorates electromagnetic conversion characteristics can be suppressed by allowing the magnetic layer to contain a resin having a mass-average molecular weight (Mw) of 120,000 or larger as a constituent component.

In Examples 1-1 to 1-19 according to the present invention, the magnetic recording media having a large capacity and a high recording density were obtained in which the surface of the magnetic layer had a center line average surface roughness (Ra) of 10 nm or less and had fine protrusions having a height of 10 to 20 nm on the surface at a rate of 1 to 500 pieces/100 μm². However, in Example 1-19, a slightly larger number of fine protrusions having a height of 10 to 20 nm on the surface, a slightly higher error rate, and slightly poorer electromagnetic conversion characteristics were obtained than in Examples 1-1 to 1-18. This may be due to a slightly larger space loss between the magnetic head and the magnetic recording medium.

In Comparative Example 1-E, the magnetic recording medium was prepared in which no undercoat layer was applied on the double-layer non-magnetic support. This prepared magnetic recording medium had a large capacity and a high recording density but was exceedingly expensive, reflecting the high price of the non-magnetic support. Thus, an inexpensive magnetic recording medium cannot be prepared using such a double-layer non-magnetic support.

These results or these tendencies were also confirmed using a polyethylene terephthalate film. A magnetic recording medium in which the amount of cupping was minus was prepared more easily using a single-layer non-magnetic support than using a layered non-magnetic support.

### (Magnetic Recording Medium Preparation -2)

Magnetic recording media were respectively prepared in totally the same way as in Examples 1-1 to 1-19 and Comparative Examples 1-A to 1E except that the non-magnetic layer and the magnetic layer were applied by a simultaneous multilayer coating method.

### (Evaluation of Magnetic Recording Medium)

The prepared magnetic recording media were evaluated in the same way as in Examples 1-1 to 1-19 and Comparative Examples 1-A to 1-E.

### (Evaluation Results)

Similar results to those of Examples 1-1 to 1-19 and Comparative Examples 1-A to 1-E were obtained. Thus, it was confirmed that the present invention can be applied to the simultaneous multilayer coating method for the non-magnetic layer and the magnetic layer.

However, the magnetic recording media prepared by the simultaneous multilayer coating method were slightly inferior in electromagnetic conversion characteristics to the magnetic recording media of Examples 1-1 to 1-19 prepared by the successive multilayer coating method, due to the partial mixing of the magnetic layer and the non-magnetic layer.

What is claimed is:

1. A magnetic recording medium comprising, in order from a surface side toward a back surface side:
a magnetic layer;
a non-magnetic layer;
an undercoat layer;
a non-magnetic support; and
a back coat layer, wherein
the non-magnetic support comprises a single-layer polyester-based member,
the undercoat layer contains a radiation-curable compound which has been cured by radiation and has a film thickness of 2.0 μm or smaller, and
cupping is formed such that an amount of cupping on the surface side is 0 mm or less.

2. The magnetic recording medium according to claim 1, wherein
the non-magnetic support comprises a polyester-based member mainly composed of polyethylene-2,6-naphthalene dicarboxylate.

3. The magnetic recording medium according to claim 1, wherein the non-magnetic support
has a film thickness of 10 μm or smaller,
contains first inactive fine particles having an average particle size (D50) of 0.05 μm or larger and smaller than 1.5 μm and comprising at least one or more components,
is free from inactive fine particles having an average particle size (D50) of 1.5 μm or larger, and
has a center line average surface roughness of 1 nm or more and 50 nm or less on the surface side.

4. The magnetic recording medium according to claim 1, wherein
second inactive fine particles having the largest average particle size (D50) among inactive fine particles contained in the non-magnetic support, are monodisperse fine particles in a spherical form having a particle size distribution value (D25/D75) of 2.0 or less.

5. The magnetic recording medium according to claim 1, wherein
the amount of cupping is 0 mm to −2.0 mm.

6. The magnetic recording medium according to claim 5, wherein the non-magnetic support
has a film thickness of 10 μm or smaller,
contains first inactive fine particles having an average particle size (D50) of 0.05 μm or larger and smaller than 1.5 μm and comprising at least one or more components,
is free from inactive fine particles having an average particle size (D50) of 1.5 μm or larger, and
has a center line average surface roughness of 1 nm or more and 50 nm or less on the surface side.

7. The magnetic recording medium according to claim 5, wherein
second inactive fine particles having the largest average particle size (D50) among inactive fine particles contained in the non-magnetic support, are monodisperse fine particles in a spherical form having a particle size distribution value (D25/D75) of 2.0 or less.

8. The magnetic recording medium according to claim 5, wherein
the non-magnetic support comprises a polyester-based member mainly composed of polyethylene-2,6-naphthalene dicarboxylate.

9. The magnetic recording medium according to claim 8, wherein
second inactive fine particles having the largest average particle size (D50) among inactive fine particles contained in the non-magnetic support, are monodisperse fine particles in a spherical form having a particle size distribution value (D25/D75) of 2.0 or less.

10. The magnetic recording medium according to claim 8, wherein the non-magnetic support
has a film thickness of 10 μm or smaller,
contains first inactive fine particles having an average particle size (D50) of 0.05 μm or larger and smaller than 1.5 μm and comprising at least one or more components,
is free from inactive fine particles having an average particle size (D50) of 1.5 μm or larger, and
has a center line average surface roughness of 1 nm or more and 50 nm or less on the surface side.

11. The magnetic recording medium according to claim 10, wherein
second inactive fine particles having the largest average particle size (D50) among inactive fine particles contained in the non-magnetic support, are monodisperse fine particles in a spherical form having a particle size distribution value (D25/D75) of 2.0 or less.

12. The magnetic recording medium according to claim 10, wherein
the first inactive fine particles comprise at least one of silica fine particles and silicone fine particles.

13. The magnetic recording medium according to claim 12, wherein
second inactive fine particles having the largest average particle size (D50) among inactive fine particles contained in the non-magnetic support, are monodisperse fine particles in a spherical form having a particle size distribution value (D25/D75) of 2.0 or less.

14. The magnetic recording medium according to claim 1, wherein the magnetic recording medium is produced by:
applying an application solution for an undercoat layer containing the radiation-curable compound onto the non-magnetic support and then drying the application solution for an undercoat layer while curing the radiation-curable compound to thereby form the undercoat layer;
after the drying of the undercoat layer and the cure of the radiation-curable compound, applying an application solution for a non-magnetic layer onto the undercoat layer and drying the application solution for a non-magnetic layer to thereby form the non-magnetic layer; and
after the formation of the non-magnetic layer, applying an application solution for a magnetic layer onto the non-magnetic layer and drying the application solution for a magnetic layer to thereby form the magnetic layer.

15. The magnetic recording medium according to claim 1, wherein
the undercoat layer is substantially free from particles comprising an inorganic compound and particles comprising an organic compound.

16. The magnetic recording medium according to claim 1, wherein
the undercoat layer comprises a migration component to migrate into the non-magnetic layer or the magnetic layer, and
the radiation-curable compound is cured such that the migration component in the undercoat layer has a concentration of 10% by mass or lower.

17. The magnetic recording medium according to claim 1, wherein
the undercoat layer is free from a migration component to migrate into the non-magnetic layer or the magnetic layer.

18. The magnetic recording medium according to claim 1, wherein
the radiation-curable compound contained in the undercoat layer is cured such that the volume shrinkage of the undercoat layer is 20% or less.

19. The magnetic recording medium according to claim 1, wherein
the radiation-curable compound contained in the undercoat layer is cured in an atmosphere with an oxygen concentration of 1000 ppm or lower.

20. The magnetic recording medium according to claim 1, wherein
the magnetic layer comprises a powdery ferromagnet and a binder,
the binder comprising a resin having a mass-average molecular weight of 120,000 or larger.

21. The magnetic recording medium according to claim 1, wherein
the surface of the magnetic recording medium on the side where the magnetic layer is formed relative to the non-magnetic support has a center line average surface roughness of 10 nm or less and has protrusions having a height of 10 nm or higher and 20 nm or lower at a rate of 1 to 500 pieces/100 μm².

22. A method for producing a magnetic recording medium according to claim 1, comprising the steps of:
continuously forming an undercoat layer, a non-magnetic layer, and a magnetic layer in this order onto a non-magnetic support sent from a non-magnetic support master roll to thereby obtain a magnetic recording medium web, which is then winded to produce a magnetic recording medium master roll; and
cutting the magnetic recording medium web unwound from the magnetic recording medium master roll into tapes.
